(19) United States
(12) Patent Application Publication
(10) Pub. No.: US 2010/0060562 A1
(43) Pub. Date: Mar. 11, 2010

(54) STRAY LIGHT COMPENSATION IN AMBIENT LIGHT SENSOR

(76) Inventors: Benjamin James Hadwen, Oxford (GB); Christopher James Brown, Oxford (GB); Michael Paul Coulson, Oxford (GB); Patrick Zebedee, Oxford (GB)

Correspondence Address: NIXON & VANDERHYE, PC, 901 NORTH GLEBE ROAD, 11TH FLOOR, ARLINGTON, VA, 22203, US

(21) Appl. No.: 12/524,021

(22) PCT Filed: Apr. 21, 2008
(86) PCT No.: PCT/JP2008/058161

§ 371 Date: Jul. 22, 2009

(30) Foreign Application Priority Data
Apr. 20, 2007 (GB) 0707661.5

(51) Int. Cl. G09G 3/36; G01J 1/16; H05B 37/02

(52) U.S. Cl. 345/102; 356/221; 356/222; 250/208.2; 315/149

(57) ABSTRACT

A method is provided of compensating for stray light in a light sensor having a detection photosensor (7) and a reference photosensor (20), the reference photosensor (7) being for use in compensating for stray light falling on the detection photosensor (20). The method comprises using the reference photosensor (20) at least in part to determine a bias voltage applied to the detection photosensor (7). Based on this method, a display device is provided comprising a backlight and a light sensor for determining an ambient light level with the effects of stray light from the backlight substantially removed, with means provided for controlling the intensity of the backlight in dependence upon the determined ambient light level.

### TECHNICAL FIELD

The present invention relates to stray light compensation in light sensor devices. The present invention relates particularly but not exclusively to photosensor devices that are integrated into an active matrix liquid crystal display (AMLCD). For example, the present invention finds particular application in the integration of an ambient light sensor (ALS) on the AMLCD display substrate.

### BACKGROUND ART

FIG. 2 of the accompanying drawings shows a simplified cross section of a typical AMLCD. The backlight is a light source used to illuminate the display. The transmission of light through the display, from the backlight 101 to the viewer 102, is controlled by the use of electronic circuits made from thin film transistors (TFTs). The TFTs are fabricated on a glass substrate (known as the TFT glass 103) and are operated so as to vary the electric field through the Liquid Crystal (LC) 104 layer. This in turn varies the optical properties of the LC material and thus enables the selective transmission of light through the display, from the backlight 101 through to the viewer 102.

In many products which utilise displays (e.g. mobile phones, Personal Digital Assistants (PDAs)) it is found to be useful to control the light output of the backlight according to ambient illumination conditions. For example under low ambient lighting conditions it is desirable to reduce the brightness of the display backlight and hence also the brightness of the display. As well as maintaining the optimum quality of the display output image, this allows the power consumed by the backlight to be minimised.

In order to vary the intensity of the backlight in accordance with the ambient lighting conditions, it is necessary to have some means for sensing the level of ambient light. An ambient light sensor used for this purpose could be separate from the TFT glass substrate. However often there are several advantages of integrating the ALS onto the TFT glass substrate (“monolithic integration”), for example in reducing the size, weight and manufacturing cost of the product containing the display.

A typical practical ambient light sensor system is shown in FIG. 1 of the accompanying drawings, and contains the following elements:

(a) A photodetection element (or elements) capable of converting incoming light to electrical current. An example of such a photodetection element is a photodiode 2.

(b) Bias circuitry 3 to control the photodetection element(s) and sense the photo-generated current.

(c) Output circuitry 4 to supply an output signal (analogue or digital) representing the measured ambient light level.

(d) A means 5 of adjusting the display operation based on the measured ambient light level, for example by controlling the intensity of the backlight 6.

FIG. 3 of the accompanying drawings shows a photodiode, a two terminal device with an anode 8 and cathode 9.

In the case of an AMLCD with a monolithically integrated ambient light sensor, the basic photodetection device used must be compatible with the TFT process used in the manufacture of the display substrate. A well-known photodetection device compatible with the standard TFT process is the lateral, thin-film, polysilicon P-I-N diode, as shown in FIG. 4 of the accompanying drawings. This device consists of a p-type region of semiconductor material (in this case polysilicon) which forms the anode 8 of the device and an n-type region of semiconductor material which forms the cathode 9 of the device. Between the n- and p-type regions is a region of intrinsic or lightly doped semiconductor material (silicon) 7. This forms the photosensitive part of the device, being capable of converting incoming light to an electrical current.

To operate such a photodiode, a potential difference must be applied between the two photodiode terminals, the anode 8 and the cathode 9. The typical current-voltage (IV) characteristics of a photodiode are shown in FIG. 5 of the accompanying drawings, with device in darkness 12 and with the device illuminated by some light level A 13. Here the applied photodiode bias is the potential difference between the anode and the cathode.

It is often convenient to re-plot the IV characteristics with the y axis on a logarithmic scale denoting the absolute value of the photocurrent.

The photodiode IV characteristics are shown in FIG. 6 of the accompanying drawings, with the device in darkness 12, with the device illuminated by some light level A 13, and with the device illuminated by light level B 14 where light level B is in excess of light level A.

It can be seen from FIG. 6 that illuminating the device changes the current flowing through it for any given operating bias. For operation of the device at a given bias voltage, the current that is generated with the device in darkness can be termed the “leakage current” (or “dark current”) of the device. The current that is generated with the device illuminated can be termed the “light current”. This consists of the sum of the leakage current and that portion of the current which is generated in response to the incident light (this latter portion being termed “photocurrent”).

The bias at which the photodiode current is zero is generally referred to as the photodiode open circuit voltage and denoted VOC(A) for light level A 38 and VOC(B) for light level B 39. The open circuit voltage is a function of both the light level and the temperature, increasing as the light level increases and decreasing as temperature increases. Under the special case where the incident light level is zero, the open circuit voltage is known as the built-in voltage Vbi 37. In many implementations of thin film photodiodes the built-in voltage is equal, or nearly equal to 0 Volts. It is always the case that VOC>Vbi since the sign of the photo-generated component of diode current is always negative.

Photodiodes fabricated in a polysilicon TFT process have in general a low sensitivity for two principal reasons:

1. The photo current is generally small, typically being limited by the thickness of the thin film semiconductor material.

2. The leakage current is generally large, typically due to the high density of defect states in the semiconductor material.

In many applications the sensitivity limit of the photodiode is determined by the relative contributions of the photocurrent and the leakage current. If the photocurrent is smaller than the leakage current then it becomes difficult to detect. Additionally, the leakage current is generally very strongly temperature dependent, increasing with increasing temperature. Accordingly, an ambient light sensor whose sensing element is a thin-film polysilicon photodiode is likely to exhibit poor sensitivity, especially at higher operating temperatures.

A photodiode is not the only possible photosensor device for converting incoming light to current. One alternative well known possibility is a phototransistor, whose drain-source current is a function of the incident light level. Phototransistors can be operated with the gate connected to either the drain, the source, some other external bias supply or with the gate left floating.

A further possible photosensitive device is a photo-resistor (a devices whose electrical resistance is a function of the incident light level), and various other possibilities also exist.

To maximise the sensitivity of a photodetection element such as a thin film photodiode it is advantageous to bias the photodetection element such that the ratio of the photocurrent to the leakage current is maximised, i.e. at the built-in voltage of the device.

FIG. 7 of the accompanying drawings shows a well known circuit implementation for biasing a photosensor device at zero volts and measuring the current generated. This circuit contains the following elements:

A photodiode 7 which is exposed to ambient light

An operational amplifier 51 of standard construction.

An integration capacitor C_{INT} 52

A switch S1 53.

An Analogue to Digital Converter (ADC) 81 of standard construction.

The operation of this circuit is as follows:

Prior to the beginning of the integration period, the switch S1 53 is closed. This resets the potential across the integration capacitor C_{INT} 52 to 0 Volts.

At the beginning of the integration period the switch S1 53 is opened.

The operational amplifier 51 operates so that (in the ideal case) the potential difference between the inverting and non-inverting input terminals is zero. As a consequence a potential of zero volts is developed at the non inverting input of the operational amplifier 51.

Since the cathode of the photodiode 7 is at 0 Volts, a potential difference of zero volts is developed across the terminals of the photodiode 7.

During the integration period the detection photodiode generated a current I_{P} according to the intensity of ambient light incident upon it. This current is then integrated onto the integration capacitor C_{INT}.

The change of voltage at the output of the operational amplifier 51 between the start and the end of the integration period is then sampled. This change in voltage is equal to I_{P}/C_{INT} multiplied by the integration time.

The voltage level at the output of the comparator is then converted to a digital output by the ADC 81. This digital output then represents the measured ambient light level.

Another example of a well known circuit implementation for biasing a photosensor device at zero volts and measuring the current generated is a transimpedance amplifier, shown FIG. 8 of the accompanying drawings. This circuit contains the following elements:

A photodiode 7 which is exposed to ambient light

An operational amplifier 51 of standard construction.

A feedback resistor R_{F} 130

An Analogue to Digital Converter (ADC) 81 of standard construction.

The operation of this circuit is as follows:

The operational amplifier 51 operates so that (in the ideal case) the potential difference between the inverting and non-inverting input terminals is zero. As a consequence a potential of zero volts is developed at the non inverting input of the operational amplifier 51.

Since the cathode of the photodiode 7 is at 0 Volts, a potential difference of zero volts is developed across the terminals of the photodiode 7.

The detection photodiode generated a current I_{P} according to the intensity of ambient light incident upon it.

Since no current can flow into the inverting input of the operational amplifier, a current I_{P} passes through the feedback resistor R_{F} 130. As a consequence a potential of −I_{P}R_{F} is generated at the output of the operational amplifier 51.

The voltage at the output of the operational amplifier 51 can then be sampled and measured by the ADC 81.

Another example of a circuit implementation for biasing a photosensor device at zero volts and measuring the current generated is the feed-forward technique described in “Circuit Techniques for Reducing the effects of OP-amp Imperfections: Autozeroing, correlated Doubling Sampling and Chopper Stabilisation”, Christian C. Enz and Gabor C. Temes, Proceedings of the IEEE, vol. 84, No. 11. November 1996. pp 1584-1614 and is shown FIG. 9 of the accompanying drawings. This circuit contains the following elements:

A photodiode 7 which is exposed to ambient light

An operational amplifier 51 of standard construction.

A second nulling amplifier 131 of standard construction.

A single pole double throw (SPDT) switch S2 135

A single pole double throw switch S3 134

A capacitor C₁ 132

A capacitor C₂ 133

An integration capacitor C_{INT} 52

A switch S1 53.

An Analogue to Digital Converter (ADC) 81 of standard construction.

The operation of the circuit is as follows:

In the first phase of operation switch S3 is set in the upper position and switch S2 in the lower position as represented in FIG. 9. Under these conditions the nulling amplifier 131 is autozeroed and its offset voltage is generated across the terminals of capacitor C1 132.

In the second phase of operation, switch S3 is set in the lower position and switch S2 in the upper position. The offset of the operational amplifier 51 is then sampled and held on capacitor C2 whilst the nulling amplifier 131 is zeroing its own offset.

The switch S1 is then closed so that the photocurrent I_{P} is integrated, in exactly the same way as has already been described for the standard integrator arrangement of FIG. 7.

An advantage of using the feed-forward technique is that the low offset nulling amplifier 131 can be used to sense any offset voltage of the operational amplifier 51 and generate a correction voltage that is then applied to the non inverting input of the operational amplifier 51 to cancel its own offset.

In FIG. 9 shows the feed-forward technique is combined with the integrator arrangement of FIG. 7. It will be apparent to one skilled in the art that the feed-forward technique could be just as easily combined with the TIA configuration shown in FIG. 8.

A further example of a circuit implementation for biasing a photosensor device at zero volts and measuring the current generated is the circuit shown in FIG. 10 of the accompanying drawings.

This circuit contains the following elements:

A photodiode 7 which is exposed to ambient light

An operational amplifier 51 of standard construction.

A second operational amplifier 151 of standard construction

An integration capacitor C_{INT} 52

A switch S1 53.

An Analogue to Digital Converter (ADC) 81 of standard construction.

The second operational amplifier 151 is configured to have unity gain and therefore buffers the connection of the inverting terminal of the first operational amplifier 51 to ground. The operation of the circuit is then exactly as has already been described for the standard integrator circuit of FIG. 7.

Practical implementations of the circuits of FIGS. 7-10 generally require the bias across the terminals of the photodiode to be maintained at zero to a fairly high degree of precision in order to maximise the sensitivity to incident ambient light. In practice, accurate implementation of the circuit of FIG. 7 may be difficult since the circuit components are non ideal. This is particularly the case when the circuit components are required to be integrated onto the TFT substrate. Our co-pending British Patent Application No. 0619581.2 describes a method for easing the precision biasing requirements by series connecting a number of photodiode elements in series, as shown FIG. 11 of the accompanying drawings.

As well as obtaining a sufficiently high ratio of photocurrent to leakage current, a further practical difficulty in many applications is the requirement to compensate the light measuring circuit to offset for the effects of unwanted (“stray”) light. For example in an ALS integrated into an AMLCD, the photosensor element may well be subject to stray light in addition to the ambient light that is being detected. Such stray light may originate (for example) from the display backlight and find its way into the photodiode, for example by means of single or multiple reflections within the glass substrate or from reflective structures (such as metal layers) surrounding the photodiode. The effects of stray light are a particular concern when the light sensor is integrated into the display as, even with careful design, minimising the stray light to levels comparable to or below the lowest detectable ambient light levels may in practice be very difficult.

In such a system, any attempt to compensate for the effects of stray light must be dynamic, i.e. the compensation method that is used must be capable of adjustment. This is because in general the amount of stray light will depend on the set brightness of the backlight which is itself being controlled in response to the ambient lighting conditions.

A number of compensation schemes for correcting a photosensor output to deal with the problems of leakage current and stray light will now be described.

The following prior art describes inventions whereby the bias across the terminals of the photodiode is controlled so as to maximise the device's sensitivity as a photosensor.

EP1128170A1 describes a method whereby the current through the photodiode is measured and compared with a reference value. The photodiode bias circuit is then adjusted according to whether the measured current is higher or lower than this pre-determined reference value. The photodiode bias can be adjusted over a relatively wide range to cope with large changes in the incident light level. Thus by choice of a suitable reference value the photodiode can be operated in its most sensitive region at low incident light levels, but then for higher incident light levels the bias can be changed so as to avoid saturation of the output signal.

US20050205759A1 describes an optical receiver in a communications system and describes how the photosensor bias voltage can be dynamically controlled by means of a feedback loop and signal processing in the digital domain so as to optimise the value of a chosen detection performance parameter.

US20030122533A1 describes a circuit to control the bias applied across a photodiode based on a measurement of the generated current. In this case the biasing circuitry described fulfils a requirement to vary the applied bias over a large range. The method employed for determining the bias to be set is similar to EP1128170A1 and US20050205759A1, based upon detection of the photodiode current and the use of a feedback mechanism.

US20060119424A1 describes an offset compensation scheme utilising a single photodiode sensor at the input of an operational amplifier. The offset voltage of the system is compensated for by performing a photodiode test and then switching in variable resistors and current sources to change the biasing conditions of the photodiode.

The above prior art EP1128170A1, US20050205759A1, US20030122533A1, US20060119424A1 all make use of just a single photo-sensing element, whose operating bias is adjusted in accordance with the measurement conditions. The disadvantage of these schemes lies in the complexity of their practical circuit implementations and the amount of processing power that they require in order to perform the compensation. In particular this means that these schemes would not be well suited to integration into an AMLCD, due to both the number of and the performance requirements of the circuit components that would need to be monolithically integrated. An additional disadvantage is that these schemes may well be poorly suited to operation in an environment where the requirements for compensation may be constantly changing (e.g. due to changes in ambient light level and/or temperature).

A different and common technique for compensating for the effects of stray illumination is to incorporate a second light sensor element into the AMLCD. The AMLCD thus contains two light sensing elements which, for example, could be two photodiode. Employing this technique, the first photodiode, shown FIG. 4 and termed the “detection photodiode” is exposed to the incident ambient light. The second, shown FIG. 12 of the accompanying drawings, we termed the “reference photodiode”. The photosensitive region of the reference photodiode is shielded from the incident ambient light by some means, for example with a light blocking layer 21.

Such a light blocking layer could in practice consist be of any one or more of the opaque layers used in the AMLCD manufacturing process. For example it could be a metal layer used to fabricate the display electronics or it could be an opaque resin layer such as the Black Matrix (BM) layer commonly used in display fabrication. It could also consist of any opaque material that is separate from the display substrate and placed between the display substrate and the incoming ambient light.

An example construction of detection and reference photodiodes, as fabricated in an AMLCD process are shown in FIG. 13 of the accompanying drawings. Our co-pending British Patent Application No. 0702346.8 describes a method for fabricating detection and reference photodiodes in an AMLCD process that are electrically and optically well matched.

The detection photodiode generates a total current in accordance with three contributing components:

(i) photocurrent generated due to the detection of ambient light

(ii) photocurrent generated due to the detection of stray light

(iii) leakage current

The reference photodiode, on the other hand, is shielded from ambient light, and so the current generated is just that due to components (ii) and (iii).

The use of two photodiode sensor elements, one as a detection sensor element and the other as a reference sensor element, to compensate for the effects of stray light and dark signal is very well known, as for example in EP1394 859A2.

A general requirement for successful compensation using the two photodiode technique is that the detection and reference photodiodes are well matched electrically and optically. To be well matched electrically the two photodiodes must have nominally identical IV characteristics for a given bias voltage, operating temperature and incident light level. To be well matched optically the detection and reference photodiodes should be subject to nominally the same levels of stray light.

If the detection and reference photodiodes are designed to be well matched electrically and optically the difference in their outputs can be used to determine the ambient light level, thus compensating for the effects of stray illumination. Additionally such a compensation scheme can be used to compensate for the effects of leakage current (and its variation with temperature) since the leakage current will be nominally the same in the detection and reference devices and thus cancel when a subtraction is performed.

The prior art that follows relates to the way in which the outputs of the detection and reference photodiodes are combined to calculate the ambient light level.

JP Patent Application JP2005-132938 describes a scheme whereby the output current from each of the detection and reference photodiodes are subtracted in the voltage domain, shown in FIG. 14 of the accompanying drawings. By the term “subtracted in the voltage domain” it is meant that the output currents generated by each of the reference and detection photo-sensors are first converted to analogue voltage signals, and then these voltages are subtracted.

The measurement circuit operates by integrating the output current of the reference photodiode 20 onto a first capacitor 101, and the output of the detection photodiode 7 onto a second integration capacitor 102. The biases developed across these capacitors are then the biases at the inputs of a comparator 81. Thus the voltages developed across the two capacitors are subtracted from one another so that the output voltage signal is proportional to the difference between them. The result is that the circuit measures a voltage that is dependent on the difference between the light level incident upon the detection and reference photodiodes.

Subtraction in the current domain is illustrated graphically in FIG. 16A, which shows a representative plot of absolute photodiode current (on a logarithmic scale) against applied photodiode bias for the reference and detection photodiodes (the former receiving stray light only, and the latter receiving stray and ambient light). In the illustrated example, a bias voltage of 0V is applied to both photodiodes, so that, resulting in a current readout of I1 from the detection photodiode and a current readout of I2 from the reference photodiode. The difference between these two currents, I1-I2, is representative of the ambient-only contribution.

With such a method, it can become difficult to perform the subtraction operation accurately in the case when the current generated due to stray light level becomes comparable to, or bigger than, the photocurrent generated by ambient light level that the arrangement is trying to detect. In addition, in cases where the current generated by ambient light level is comparable to, or smaller than, the current due to a combination of the leakage and stray light components, accurate subtraction requires the detection and reference photodiodes to be matched to a high precision, both electrically and optically. This is because any difference in the leakage current or the current due to stray light due to mismatch of the two devices will appear in the subtracted result.

US2006180747 describes a similar subtraction method, with the additional stated refinement that the measured outputs from the detection and reference photodiodes are converted first to voltage then to digital signals prior to subtraction. This scheme suffers from the same disadvantages as above.

WO02103938 describes an offset compensation scheme using detection and reference photodiodes at the input of a differential transimpedance amplifier. This scheme is in essence a voltage subtraction method and so suffers from the same disadvantages as other subtraction schemes noted previously.

U.S. Pat. No. 5,117,099 describes a scheme whereby the currents from the detection and reference photodiodes are subtracted in the current domain, as shown in FIG. 15 of the accompanying drawings. This is achieved by arranging the detection and reference photodiodes in a loop, with the anode of the detection photodiode connected to the cathode of the reference photodiode 24, and the cathode of the detection photodiode connected to the anode of the reference photodiode 25.

U.S. Pat. No. 6,903,362B2 also describes a scheme for subtracting in the current domain whereby the cathodes of the detection and reference photodiodes are connected together and their anodes are connected to the terminals of a differential current amplifier. The output is therefore the difference between the currents generated by the two photodiodes.

“LTPS Ambient Light Sensor with Temperature Compensation”. S. Koide, S. Fujita, T. Ito, S. Fujikawa, T. Matsumoto. Proceedings of 13^{th} International Display Workshop Volume 2 (December 2006) (p 689-690) describe an ambient light sensor integrated on AMLCD. Here a detection and a reference photodiode are implemented with the detection photodiode exposed to ambient light and the reference photodiode shielded from ambient light. The photodiodes are arranged in a three terminal configuration as shown in FIG. 16B of the accompanying drawings, with the anode of the reference photodiode and the cathode of the detection photodiode connected together to form one terminal, the anode of the detection photodiode forming a second terminal and the cathode of the reference photodiode forming a third terminal. The outputs from the two photodiodes are thus subtracted in the current domain.

An advantage of the systems described in U.S. Pat. No. 5,117,099, U.S. Pat. No. 6,903,362B2 and WO 02103938 compared to those described in JP Patent Application JP2005-132938 and US2006180747 is that performing the subtraction in the current domain is likely to be more accurate than performing the subtraction post I-V conversion. However these current subtraction methods still suffer from the inherent disadvantages mentioned for JP Patent Application JP2005-132938, in particular that it becomes difficult to perform the necessary subtraction accurately when the ambient light level is smaller than either the stray light level or the leakage current.

The system of U.S. Pat. No. 6,903,362B2 where the photodiodes are connected in a loop also suffers from the disadvantage that the bias maintained across the photodiodes needs to be held at 0 Volts quite accurately. Any deviation of this voltage from 0 Volts will result in one of the photodiodes being slightly forward biased and the other being slightly reverse biased with the result that the dark current from the two photodiodes will no longer exactly cancel one another.

It is desirable to address at least some of the above-identified technical problems associated with the prior art.

### DISCLOSURE OF INVENTION

According to a first aspect of the present invention, there is provided a method of compensating for stray light in a light sensor having a detection photosensor and a reference photosensor, the reference photosensor being for use in compensating for stray light falling on the detection photosensor, and the method comprising using the reference photosensor at least in part to determine a bias voltage applied to the detection photosensor.

The method may comprise determining the light level to be sensed by the sensor in dependence upon a current generated by the detection photosensor with the detection photosensor bias voltage applied to it.

The method may comprise determining the detection photosensor bias voltage in dependence upon the amount of stray light falling on the reference photosensor.

The method may comprise using the reference photosensor to bias the detection photosensor in substantially its most sensitive region of operation.

The method may comprise using the reference photosensor to bias the detection photosensor so as to tend to maximise the ratio of the current generated when the light level to be sensed is non-zero to the current generated when the light level to be sensed is zero.

The method may comprise deriving the detection photosensor bias voltage from a reference voltage relating to the reference photosensor.

The reference voltage may be a substantially open circuit voltage developed across the reference photosensor.

The reference voltage may be the bias voltage required to be applied to the reference photosensor such that a substantially zero current flows therethrough.

The method may comprise applying an offset voltage to the reference voltage.

Where an offset voltage is applied to the reference voltage, the offset voltage may be considered as included within the reference voltage from which the detection photosensor bias voltage is derived.

The method may comprise arranging for the detection photosensor bias voltage to be substantially the same as the reference voltage.

The method may comprise using an operational amplifier to derive the detection photosensor bias voltage from the reference voltage.

The detection photosensor and reference voltage may be connected operatively to respective inputs of the operational amplifier, with the operational amplifier being arranged so as to tend to equalise the voltages at the respective inputs, thereby tending to make the bias voltage applied to the detection photosensor equal to the reference voltage.

The operational amplifier may be a first operational amplifier, and the method may comprise using a second operational amplifier in a feed forward configuration with the first operational amplifier to sense and correct for an offset voltage of the first operational amplifier.

The operational amplifier may be a first operational amplifier, and the method may comprise using a second operational amplifier to buffer the reference voltage to the first operational amplifier.

The operational amplifier may be a first operational amplifier, and the method may comprise using a second operational amplifier connected operatively between the reference photosensor and ground.

The operational amplifier may be a first operational amplifier, and the method may comprise using a second operational amplifier connected operatively between the reference photosensor and the detection photosensor.

The method may comprise storing the reference voltage, and determining the light level to be sensed by the sensor in dependence upon a current generated by the reference photosensor with a reference photosensor bias voltage applied to it, the reference photosensor bias voltage being derived from the stored reference voltage using substantially the same circuitry as used to derive the detection photosensor bias voltage from the reference voltage.

The method may comprise determining the light level to be sensed by the sensor in dependence upon a subtraction of the detection and reference photosensor currents.

The method may comprise converting the currents to respective digital values and performing the subtraction in the digital domain.

The method may comprise storing the reference voltage using a capacitor.

The reference photosensor may be a first reference photosensor, the light sensor having a second reference photosensor also being for use in compensating for stray light falling on the detection photosensor.

The method may comprise deriving a bias voltage applied to the second reference photosensor from the reference voltage.

The method may comprise determining the light level to be sensed by the sensor in dependence upon a current generated by the second reference photosensor.

The method may comprise determining the light level to be sensed by the sensor in dependence upon a sum of or difference between the second reference photosensor current and the detection photosensor current.

The sum or difference may take place in the digital domain after conversion of the respective currents to digital.

The second reference photosensor and detection photosensors may be connected operatively in parallel.

The photosensors may each comprise at least one photosensitive element.

At least one photosensor may comprise a plurality of photosensitive elements.

At least two photosensors may each comprise a plurality of photosensitive elements.

At least one cross-connection may be provided between an inter-element node of a first photosensor and an inter-element node of a second photosensor.

The first photosensor may be the detection photosensor and the second photosensor may be the reference photosensor.

The first photosensor may be the detection photosensor and the second photosensor may be the second reference photosensor.

The first photosensor may be the first reference photosensor and the second photosensor may be the second reference photosensor.

The photosensitive elements may be connected in series.

The or each photosensitive element may comprise a photodiode.

The or each photosensitive element may comprise a lateral photodiode.

The or each photosensitive element may comprise a phototransistor.

The or each photosensitive element may comprise a thin film photosensitive element.

The or each photosensitive element may comprise a silicon thin film photosensitive element.

A physical dimension of the reference photosensor may be different to the corresponding physical dimension of the detection photosensor.

The physical dimension may be a width.

The reference photosensor width may be less than the detection photosensor width.

The reference and detection photosensors may be adapted nominally to be identical to one another.

According to a second aspect of the present invention, there is provided a method of operating a light sensor having a detection photosensor and a reference photosensor, comprising using a method according to the first aspect of the present invention to compensate for stray light falling on the detection photosensor by using the reference photosensor at least in part to determine a bias voltage applied to the detection photosensor.

The detection photosensor may be arranged to receive both the light to be sensed by the sensor and the stray light, with the reference photosensor being arranged to receive substantially only the stray light.

According to a third aspect of the present invention, there is provided a method of measuring a light level comprising using a method according to the first or second aspect of the present invention to provide a measurement of the light level with the effects of stray light substantially removed.

The light to be sensed may comprise ambient light.

According to a fourth aspect of the present invention, there is provided a method of operating a display device comprising determining an ambient light level using a method according to the first, second or third aspect of the present invention, and controlling a property of the display device in dependence upon the determined ambient light level.

The property may comprise the brightness of the display device. The brightness may result from the intensity of a backlight of the display device or the brightness of emissive display elements making up a display panel of the display device (such as in an organic light-emitting diode or OLED).

The stray light may derive from the backlight or emissive display elements, as the case may be.

The property may comprise the gamma of the display device.

According to a fifth aspect of the present invention, there is provided a light sensor comprising a detection photosensor and a reference photosensor, the reference photosensor being for use in compensating for stray light falling on the detection photosensor, and the sensor being adapted to use the reference photosensor at least in part to determine a bias voltage applied to the detection photosensor

According to a sixth aspect of the present invention, there is provided a display device comprising a backlight and a light sensor according to the fifth aspect of the present invention for determining an ambient light level, and means for controlling the intensity of the backlight in dependence upon the determined ambient light level.

The stray light may derive from the backlight.

The display device may comprise a display substrate on which display circuitry is provided, and the light sensor may be provided on the display substrate.

In each of the above-described aspects of the present invention, the word “voltage” may instead read “current”, and vice versa.

Therefore, according to a seventh aspect of the present invention, there is provided a method of compensating for stray light in a light sensor having a detection photosensor and a reference photosensor, the reference photosensor being for use in compensating for stray light falling on the detection photosensor, and the method comprising using the reference photosensor at least in part to determine a bias quantity applied to the detection photosensor. The bias quantity may be an analogue bias quantity. The quantity may be a voltage or it may be a current. Preferred features corresponding to those described above in relation to the second to sixth aspects may apply also in relation to the seventh aspect, and further aspects corresponding to the second to sixth aspects described above apply also in respect of the seventh aspect.

An embodiment of the present invention relates to a method for combining the outputs of the detection and reference photodiodes so as to measure the incident ambient light level whilst compensating for the effects of stray light.

A compensation method embodying the present invention uses at least two photo detector elements (or two sets of photo detector elements) as already been described in the prior art section: a reference photosensor and a detection photosensor which are usually, but are not restricted to being, photodiodes

A compensation method embodying the present invention operates as follows: the open circuit voltage generated across the terminals of the reference photodiode is used to bias the detection photodiode. The current generated by the detection photodiode is then measured. This current represents the ambient light level incident upon the detection photodiode; the effects of stray light have been compensated for.

The circuit to measure VOC(A) and apply this bias to the detection photodiode is preferably dynamic, since VOC(A) may vary in operation due to both changes in the circuit operating temperature and changes in the stray light level as the backlight intensity is varied.

Subtraction in the current domain according to an embodiment of the present invention is illustrated graphically in FIG. 17A, which shows a representative plot of absolute photodiode current (on a logarithmic scale) against applied photodiode bias for the reference and detection photodiodes (the former receiving substantially only stray light, and the latter receiving stray and ambient light). According to an embodiment of the present invention, it can be seen that a bias voltage is chosen for the reference and detection photodiodes that is based on operation of the reference photodiode. This contrasts to the prior art example illustrated in FIG. 16A, where a bias voltage of 0V is applied to both photodiodes, requiring a calculation of the difference between the two currents I1 and 12 to extract the ambient-only contribution. With an embodiment of the present invention, matters have been arranged effectively to make I2 of FIG. 16A zero, so that a difference calculation is no longer required: the current I1 is, on its own, representative of the ambient-only contribution. The stray light contribution has been factored out in deriving the bias voltage from the reference photodiode, bringing the graph more into line with the situation illustrated in FIG. 17B, in which there is no stray light contribution at all.

FIG. 17C is a schematic illustration of how an embodiment of the present invention operates. A method embodying the present invention effectively comprises two steps: (1) measuring the bias at which the current in the shielded (reference) photodiodes is zero; and (2) “copying” or applying this bias to the detection photodiodes (and then measuring the current through the detection photodiodes).

One advantage of a stray light compensation method embodying the present invention is that it avoids the requirement of having to subtract the current measured in the (main) reference photodiode from the current measured in the detection photodiode.

This advantage applies particularly to operation in situations where the ambient light level is small in comparison to the stray light level, where the operation of subtracting two very similar currents may result in a considerable error in the final result, particularly if the two photodiodes are not well matched.

A second advantage of an embodiment of the present invention, closely related to the first, is that both the detection sensor element is biased in its most sensitive region of operation, i.e. the ratio of the current generated when the ambient light level is non-zero to the current when the ambient light level is zero is maximised. As a result of this the effects of any mismatch in the leakage current of the detection and reference photodiodes are less significant than would be the case for example with photodiodes operated at some reverse bias voltage (for example as in prior art JP Patent Application JP2005-132938). The compensation method also automatically compensates for the temperature dependence of the leakage current since the open circuit voltage of the reference photodiode varies with temperature accordingly.

A third advantage of an embodiment of the present invention is that, unlike subtraction based referencing methods, it is not necessary for the reference photodiode to have the same width as the detection photodiode since the reference photodiode does not generate a current. Therefore the reference photodiode in some embodiments can be constructed so to have a width w1 which is much smaller width than the detection photodiode width w2, i.e. w2>>w1. The advantage of having w2>>w1 is that the area required for the ambient light sensor system can be reduced in comparison to other referencing schemes.

### BRIEF DESCRIPTION OF DRAWINGS

Reference will now be made, by way of example, to the accompanying drawings, in which:

FIG. 1, discussed hereinbefore, shows prior art: an AMLCD with integrated ambient light sensor;

FIG. 2, also discussed hereinbefore, shows prior art: a cross section of a typical AMLCD;

FIG. 3, also discussed hereinbefore, shows prior art: a photodiode;

FIG. 4, also discussed hereinbefore, shows prior art: the structure of a thin film PIN photodiode;

FIG. 5, also discussed hereinbefore, shows prior art: the typical IV characteristics of a photodiode;

FIG. 6, also discussed hereinbefore, shows prior art: the typical IV characteristics of a photodiode with the absolute value of the current plotted on a logarithmic scale;

FIG. 7, also discussed hereinbefore, shows prior art: a typical circuit implementation for biasing a photodiode at zero volts and measuring the current: an integrator circuit;

FIG. 8, also discussed hereinbefore, shows prior art: a typical circuit implementation for biasing a photodiode at zero volts and measuring the current: a transimpedance amplifier circuit;

FIG. 9, also discussed hereinbefore, shows prior art: a typical circuit implementation for biasing a photodiode at zero volts and measuring the current: an integrator circuit with feed-forward;

FIG. 10, also discussed hereinbefore, shows prior art: a typical circuit implementation for biasing a photodiode at zero volts and measuring the current: an integrator circuit with unity gain buffer;

FIG. 11, also discussed hereinbefore, shows prior art: multiple photodiodes connected in series;

FIG. 12, also discussed hereinbefore, shows prior art: a photodiode with a light blocking layer;

FIG. 13, also discussed hereinbefore, shows prior art: a detection and reference photodiode in AMLCD process;

FIG. 14, also discussed hereinbefore, shows prior art: a light sensor incorporating stray light compensation by subtraction of two measured signals;

FIG. 15, also discussed hereinbefore, shows prior art: a light sensor with stray light compensation by subtraction in the current domain;

FIG. 16A, also discussed hereinbefore, shows prior art: a graphical illustration of subtraction in the current domain;

FIG. 16B, also discussed hereinbefore, shows prior art: a light sensor with stray light compensation by subtraction in the current domain;

FIGS. 17A, 17B and 17C, also discussed hereinbefore, are for use in explaining the general concept of an embodiment of the present invention;

FIG. 18A shows a possible circuit implementation of the first embodiment;

FIG. 18B shows a possible circuit implementation of the second embodiment;

FIG. 19 shows a possible circuit implementation of the third embodiment;

FIG. 20 shows a possible circuit implementation of the fourth embodiment;

FIG. 21 shows a possible circuit implementation of the fifth embodiment;

FIG. 22 shows a possible circuit implementation of the sixth embodiment;

FIG. 23 shows a possible circuit implementation of the seventh embodiment;

FIG. 24 shows a possible circuit implementation of the eighth embodiment;

FIG. 25 shows a possible circuit implementation of the ninth embodiment;

FIG. 26 shows a possible circuit implementation of the tenth embodiment;

FIG. 27 shows a possible circuit implementation of the eleventh embodiment;

FIG. 28 shows a possible circuit implementation of the twelfth embodiment;

FIG. 29 shows a possible circuit implementation of the thirteenth embodiment;

FIG. 30 shows a possible circuit implementation of the fourteenth embodiment;

FIG. 31 shows a possible circuit implementation of the fifteenth embodiment;

FIG. 32 shows a possible circuit implementation of the sixteenth embodiment;

FIG. 33 shows a possible circuit implementation of the seventeenth embodiment;

FIG. 34 shows a possible circuit implementation of the eighteenth embodiment;

FIG. 35 shows a possible circuit implementation of the nineteenth embodiment;

FIG. 36 shows a possible circuit implementation of the twentieth embodiment;

FIG. 37 shows a possible circuit implementation of the twenty-first embodiment;

FIG. 38 shows a possible circuit implementation of the twenty-second embodiment;

FIG. 39 shows a possible circuit implementation of the twenty-sixth embodiment; and

FIG. 40 shows a possible circuit implementation of the twenty-seventh embodiment.

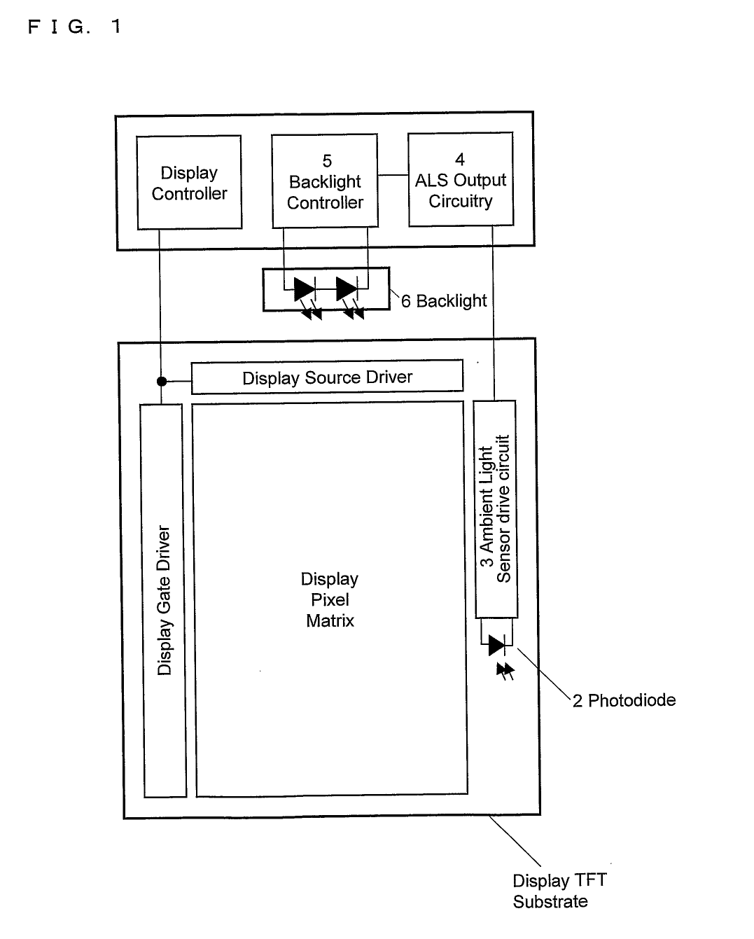

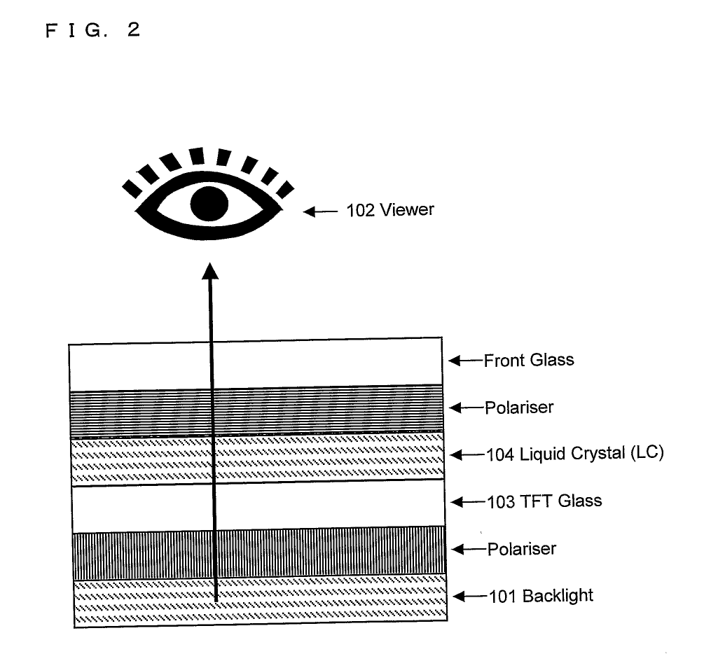

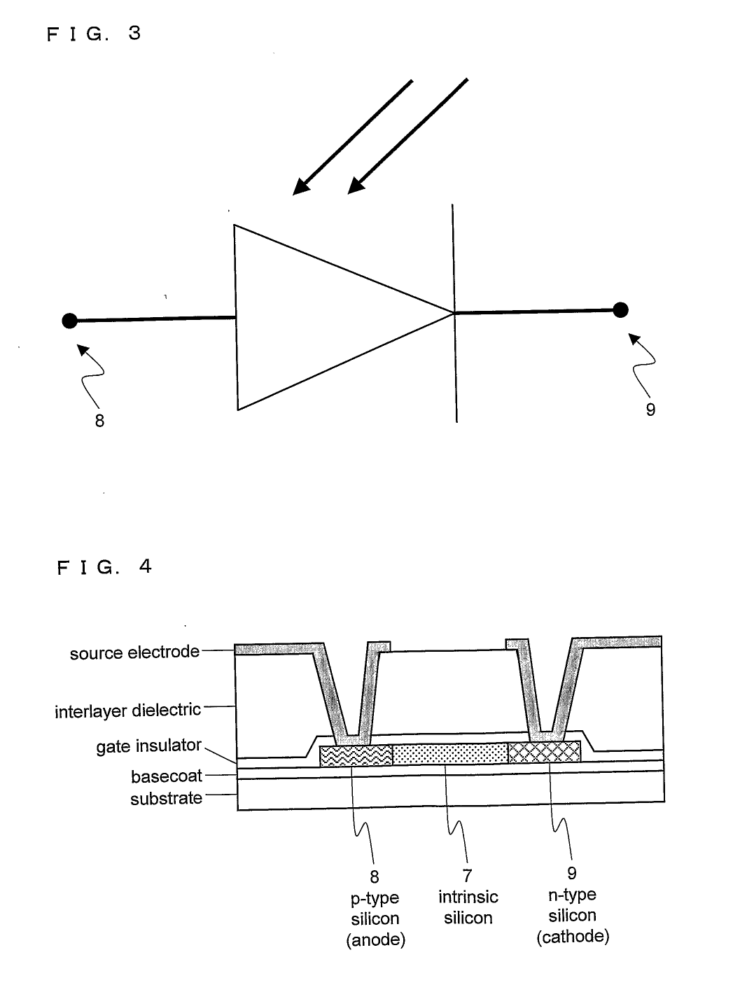

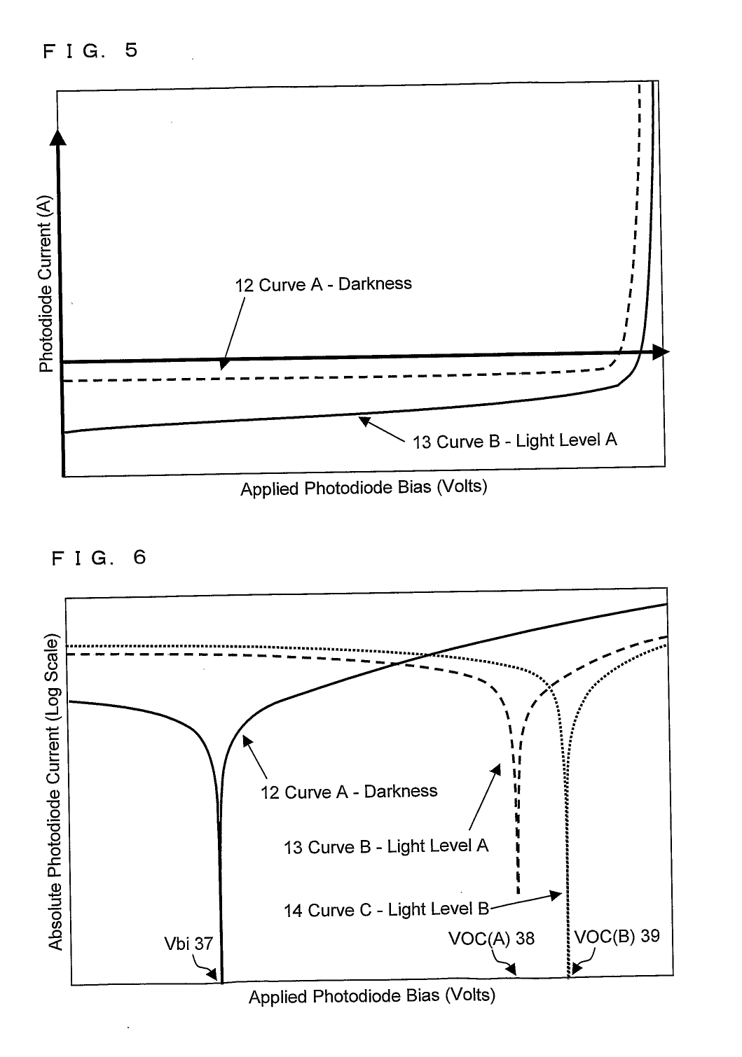

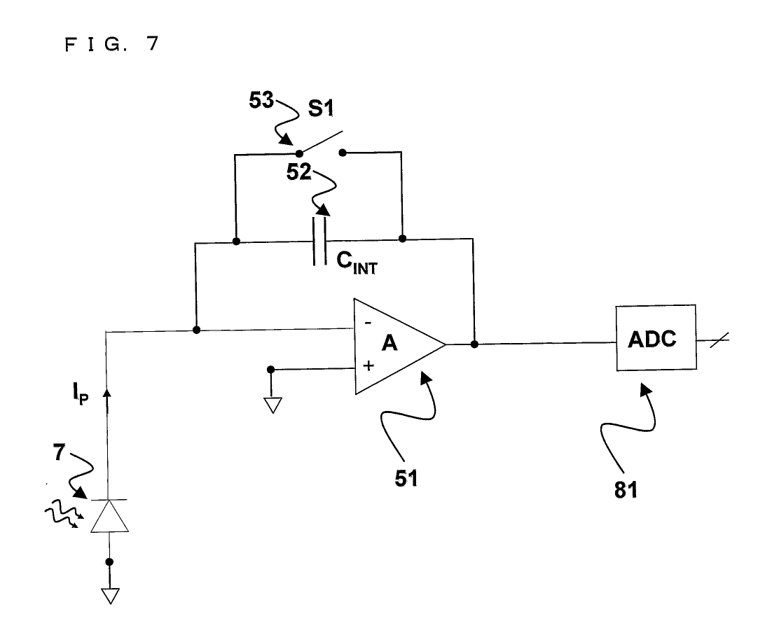

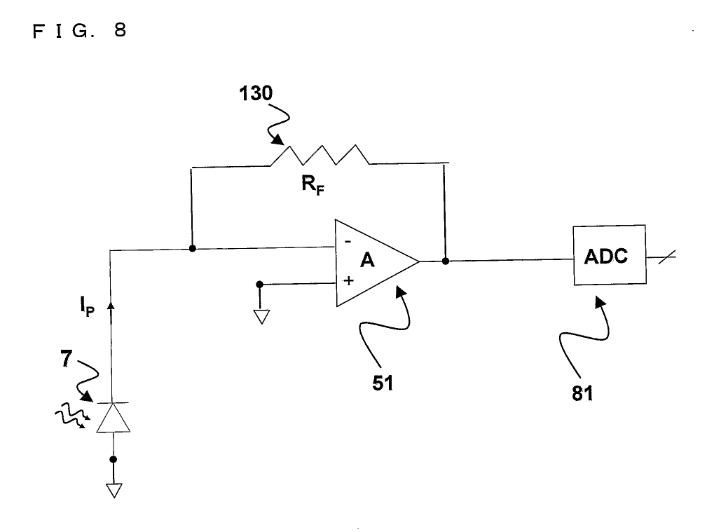

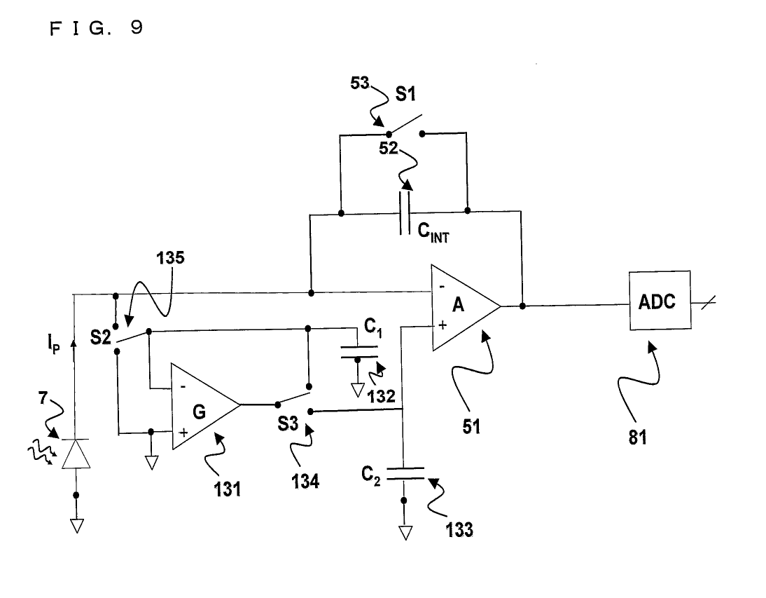

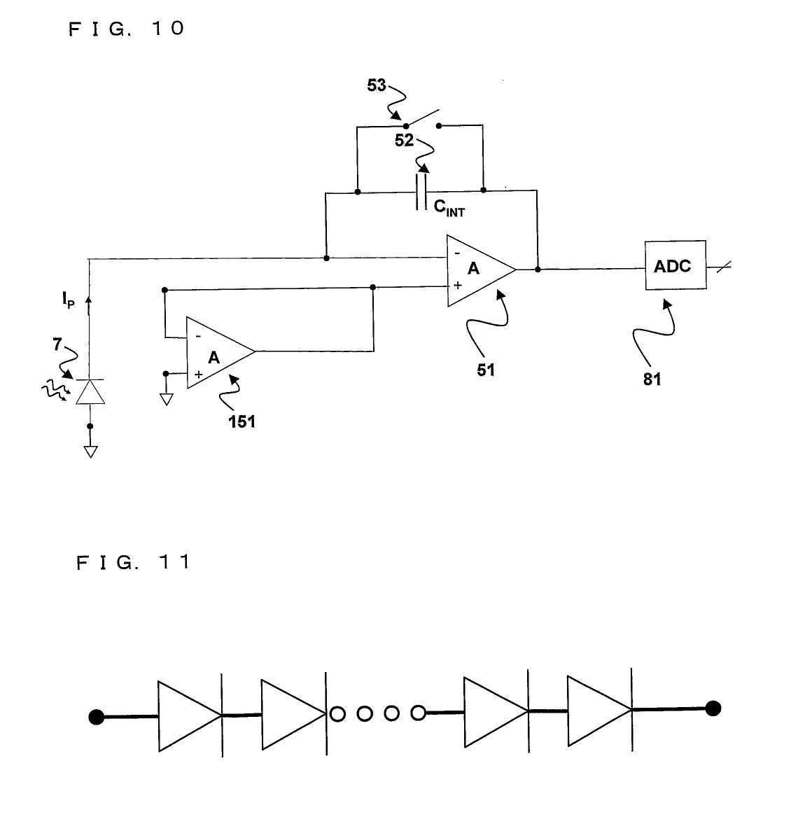

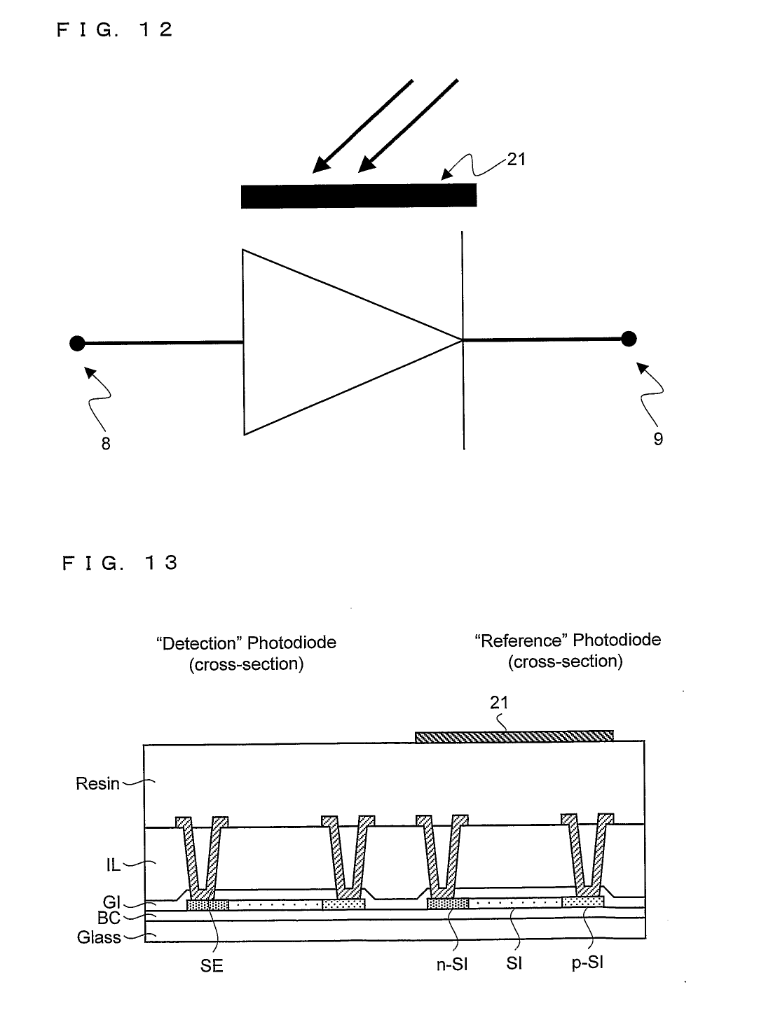

### BEST MODE FOR CARRYING OUT THE INVENTION

The first embodiment consists of a light sensor circuit comprising of the following elements:

A detection photosensor element which is exposed to ambient light

A reference photosensor element which is shielded from ambient light.

A measurement circuit which is connected to the detection and reference photosensor elements.

The detection and reference photodiodes may be designed to be nominally identical and to be both electrically and optically well matched.

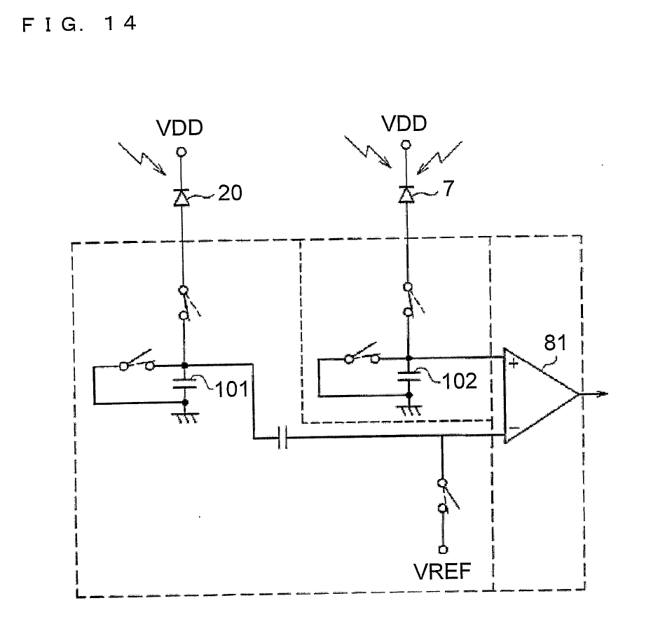

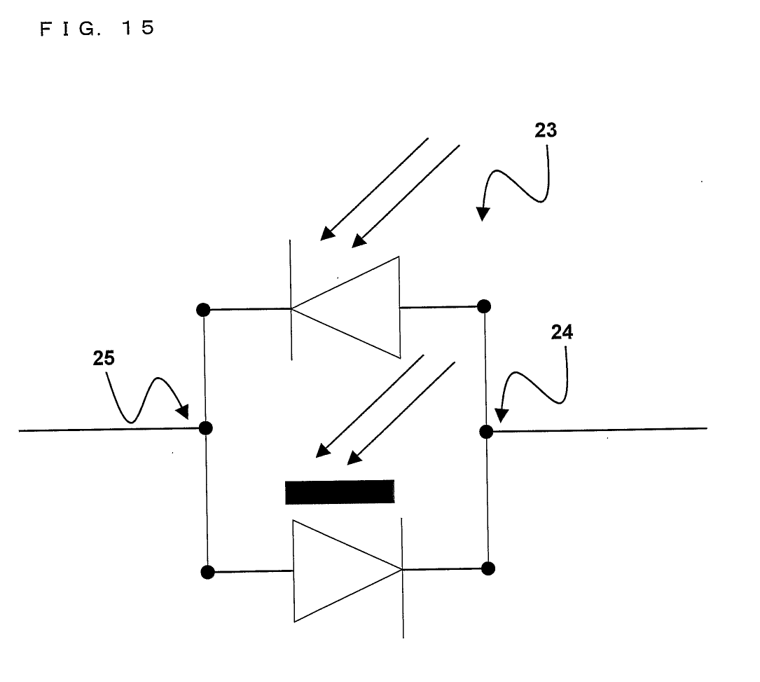

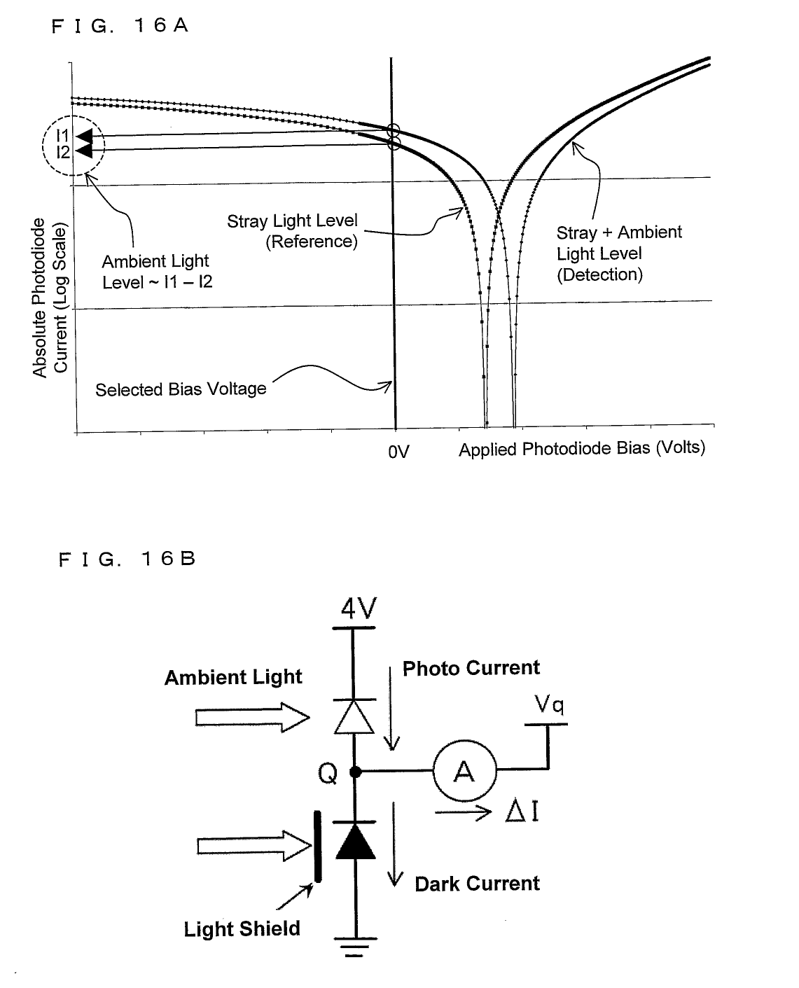

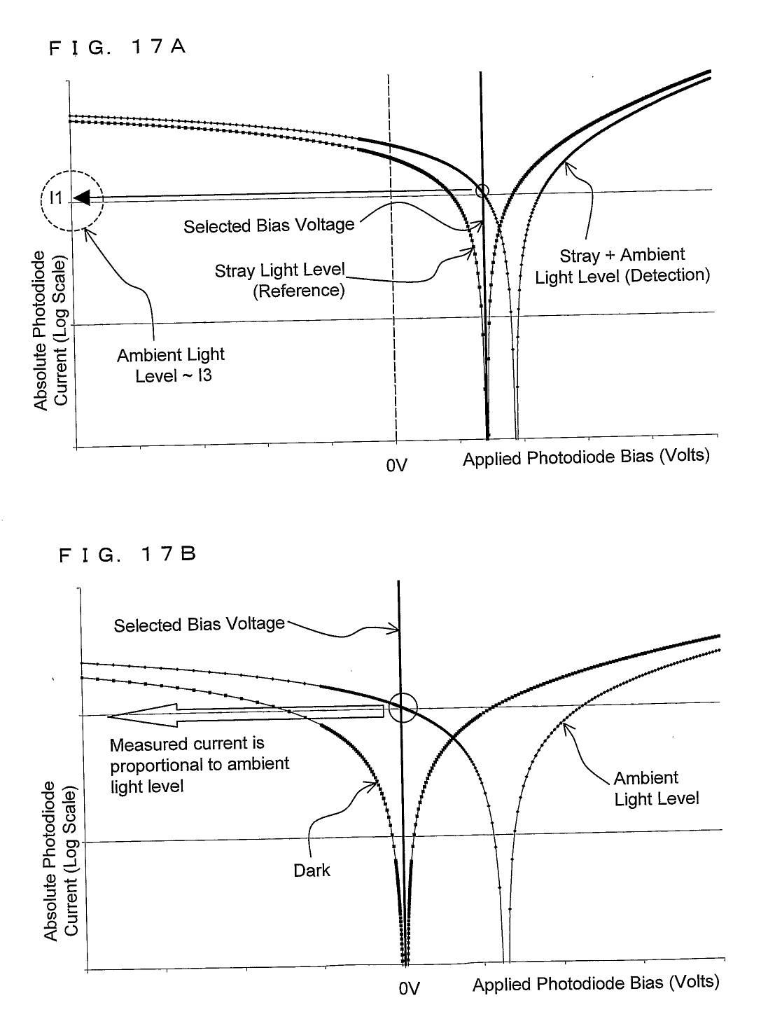

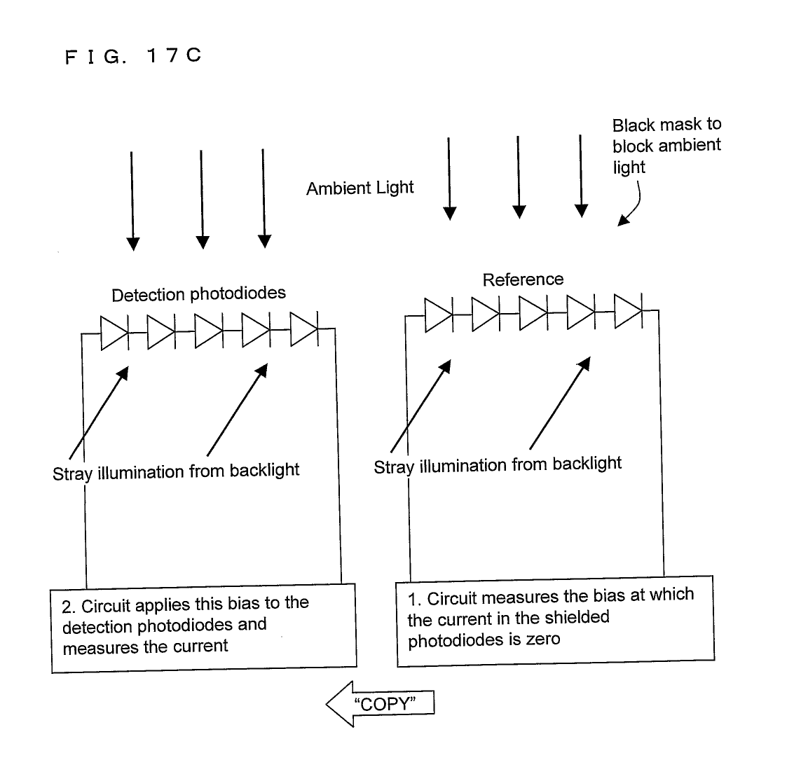

A light blocking layer is used as in FIG. 12 so that the detection photodiode is exposed to both ambient and stray light, and the reference photodiode is just exposed to ambient light.

The operation of the light sensor circuit is as follows:

(i) The measurement circuit measures the bias that needs to be applied between the terminals of the reference photosensor element such that a current substantially equal to zero flows through the reference photosensor element. The bias that the measurement circuit needs to apply in order to achieve this is then substantially equal to the open circuit bias of the reference photosensor element, VOC(A).

(ii) The measurement circuit then applies the same open circuit bias VOC(A) across the terminals of the detection photosensor element.

(iii) The measurement circuit then measures the current I_{P} that flows through the detection photosensor element whilst VOC(A) is being applied across its terminals. The measured output representative of I_{P} is denoted O_{P}. The measured output O_{P} is then representative of the ambient light level.

A practical example of a circuit for implementing this embodiment is shown in FIG. 18A. This circuit contains the following elements:

A “detection” photodiode 7 which is exposed to ambient light

A “reference” photodiode 20 which is shielded from ambient light.

An operational amplifier 51 of standard construction.

An integration capacitor C_{INT} 52

A switch S1 53.

An ADC 81 of standard construction.

The anode of the detection photodiode 7 is connected to the anode of the reference photodiode 20 which is connected to ground. The cathode of the reference photodiode 20 is connected to the non-inverting input of the operational amplifier 51. The cathode of the detection photodiode 7 is connected to the inverting input of the operational amplifier 51. The switch S1 53 is connected between the inverting input and the output of the operational amplifier 51. The integration capacitor 52 is connected between the inverting input and the output of the operational amplifier 51. The ADC 81 is connected to the output of the opamp 51.

The operation of this circuit is as follows:

Prior to the beginning of the integration period, the switch S1 53 is closed. This resets the potential across the integration capacitor C_{INT} 52 to 0 Volts.

At the beginning of the integration period the switch S1 53 is opened.

The reference photodiode 20 is connected between zero potential and the non-inverting terminal of the operational amplifier 51. Since (in the ideal case) the operational amplifier 51 has zero input current at its input terminals, a bias is generated across the terminals of the reference photodiode 20 equal to minus the open circuit voltage of the reference photodiode 20. This open circuit voltage VOC(A) is dependent upon the amount of stray light incident upon the reference photodiode 20.

The operational amplifier 51 operates so that (in the ideal case) the potential difference between the inverting and non-inverting input terminals is zero. As a consequence a potential of minus VOC(A) is developed at the non inverting input of the operational amplifier 51.

Since the cathode of the detection photodiode 7 is at 0 Volts, a potential difference of VOC(A) is developed across the terminals of the detection photodiode 7.

During the integration period the detection photodiode generated a current I_{P} according to the intensity of ambient light incident upon it. This current is then integrated and measured as has already been described in prior art. The digital output O_{P} at the output of the ADC 81 is then representative of the ambient light level.

It will be apparent to one who is skilled in the art that there are many possible alternative implementations of the schematic circuit of FIG. 18A.

An advantage of the first embodiment in addition to those mentioned previously is its simplicity since only a single additional circuit component (a reference photodiode) needs to be added to the standard integrator circuit as described in prior art.

The second embodiment consists of a light sensor comprising the following elements:

A detection photosensor element which is exposed to ambient light

A reference photosensor element which is shielded from ambient light.

A measurement circuit which is connected to the detection and reference photosensor elements.

A subtraction circuit for storing and subtracting two digital signals

The operation of the light sensor circuit of this embodiment is as follows:

(i) The measurement circuit measures the bias that needs to be applied between the terminals of the reference photosensor element such that a current substantially equal to zero flows through the reference photosensor element. The bias that the reference sensor circuit needs to apply in order to achieve this is then substantially equal to the open circuit bias of the reference photosensor element VOC(A).

(ii) The measurement circuit measures the current I_{D} that flows between the two terminals of the reference photosensor under these bias conditions. The measured output representative of I_{D} is O_{D}.

(iii) The measurement circuit then applies the same open circuit bias VOC(A) as measured by the reference photosensor element and applies it across the terminals of the detection photosensor element.

(iv) The measurement circuit then measures the current I_{P} that flows through the detection sensor element whilst VOC(A) is being applied across the terminals of the detection photosensor element. The measured output representative of I_{P} is O_{P}.

(v) The subtraction circuit then measures the difference in the two outputs O_{T}=O_{P}−O_{D}

The measured output O_{T} is then representative of the ambient light level.

A practical example of a circuit for implementing this is shown in FIG. 18B. This circuit contains the following elements:

A “detection” photodiode 7 which is exposed to ambient light

A “reference” photodiode 20 which is shielded from ambient light.

An operational amplifier 51 of standard construction.

An integration capacitor C_{INT} 52.

A switch S1 53.

A switch S2 32.

A switch S3 50

A holding capacitor C_{H} 59

A switch S4 40

A switch S5 47

An Analogue to Digital Converter 81(ADC) circuit of standard construction

A digital subtraction circuit 83 for storing and subtracting two digital signals, of standard construction

The anode of the detection photodiode 7 is connected to the anode of the reference photodiode 20 which is connected to ground. The cathode of the reference photodiode 20 is connected to the first terminal of the switch S2 32. The second terminal of switch S2 32 is connected to the non-inverting input of the operational amplifier 51. The holding capacitor 59 is connected between the non-inverting input of the operational amplifier 51 and ground. The switch S4 40 is connected between the non-inverting input of the operational amplifier 51 and ground. The cathode of the detection photodiode 7 is connected to the first terminal of the switch S5 47. The second terminal of the switch S5 47 is connected to the inverting input of the operational amplifier 51. The switch S1 53 is connected between the inverting input and the output of the operational amplifier 51. The integration capacitor 52 is connected between the inverting input and the output of the operational amplifier 51. The switch S3 50 is connected between the cathode of the reference photodiode 20 and the inverting input of the operational amplifier 51. The ADC 81 is connected to the output of the operational amplifier 51. The digital subtraction circuit 83 is connected to the output of the ADC 81.

The operation of this circuit has seven phases: (i) a first reset phase, (ii) a VOC(A) determination phase, (iii) a first integration phase, (iv) a first readout phase, (v) a second reset phase, (vi) a second integration phase and (vii) a second readout phase. The detailed operation is as follows

During the reset phase, the switches S1 53 and S4 40 are closed and switches S2 32, S3 50 and S5 47 are opened. This resets the potential across the integration capacitor C_{INT} and the potential across the holding capacitor C_{H} to 0 Volts.

At the beginning of the VOC(A) determination phase, switch S4 40 is opened and switch S2 32 is closed. Since (in the ideal case) no current can flow into the non-inverting input of the operational amplifier 51, a voltage VOC(A), equal to the open circuit voltage of the reference photodiode 20, is developed across the terminals of the holding capacitor C_{H} 59. This open circuit voltage VOC(A) is dependent upon the amount of stray light incident upon the reference photodiode 20.

At the end of the VOC(A) determination phase switch S2 32 is opened.

At the beginning of the first integration period the switch S1 53 is opened and switch S3 50 is closed.

Since the bias at the non-inverting terminal of the operational amplifier 51 is minus VOC(A), the operational amplifier 51 will work so as to maintain a bias also equal to minus VOC(A) at its non-inverting input terminal. Therefore a bias equal to VOC(A) will be maintained between the terminals of the reference photodiode 20.

During the first integration period the reference photodiode 20 generates a current I_{D} (which may not be zero in practice). This current is then integrated onto the integration capacitor C_{INT} 52 and measured during the first measurement phase as has already been described. The digital signal generated at the output of the ADC 81, denoted O_{D}, is stored in the digital subtraction circuit 83.

There now commences the second reset phase. During the second reset phase the switch S1 53 is closed and switches S2 32, S3 50, S4 40 and S5 47 are open. This resets the potential across the integration capacitor C_{INT} 52 to zero volts.

At the beginning of the second integration period the switch S1 53 is opened and switch S5 47 is closed.

Since the bias at the non-inverting terminal of the operational amplifier 51 is minus VOC(A), the operational amplifier 51 will work so as to maintain a bias also equal to minus VOC(A) at the non-inverting input terminal. Therefore a bias equal to VOC(A) will be maintained between the terminals of the detection photodiode 7.

During the second integration period the detection photodiode 7 generates a current I_{P}. This current is then integrated onto the integration capacitor C_{INT} 52 and measured during the second measurement phase as has already been described. The digital signal generated at the output of the ADC 81, denoted O_{P}, is stored in the digital subtraction circuit 83.

The two digital signals O_{P} and O_{D} are then subtracted by the digital subtraction circuit 83. The resulting digital signal O_{T} is then representative of the ambient light level.

It will be apparent to one who is skilled in the art that there are many possible alternative implementations of the schematic circuit of FIG. 18B.

An advantage of the second embodiment is that it facilitates a second order correction to account signal (correcting for example for any error in the potential applied across the terminals of the detection photodiode, due for example to a voltage offset in the op-amp between the inverting and non-inverting input terminals). It does this by also subtracting the parasitic current generated in the reference photodiode from that generated in the detection photodiode when a bias nominally equal to VOC(A) is applied across the terminals of both photodiodes.

The third embodiment of the invention consists of a light sensor circuit comprising of the following elements:

A detection photosensor element which is exposed to ambient light.

A first reference photosensor element which is shielded from ambient light.

A second reference photosensor element which is shielded from ambient light.

A measurement circuit which is connected to the detection and reference photosensor elements.

The operation of the light sensor circuit of this embodiment is as follows:

(i) The measurement circuit measures the bias that needs to be applied between the two terminals of the first reference photosensor element such that a current substantially equal to zero flows through the first reference photosensor element. The bias that the measurement circuit needs to apply in order to achieve this is then substantially equal to the open circuit bias of the first reference photosensor element VOC(A).

(ii) The measurement circuit then applies the negative of the open circuit bias VOC(A) across the terminals of the second reference photosensor element.

(iii) The measurement circuit measures the current I_{D} that flows between the two terminals of the second reference photosensor element under these bias conditions.

(iv) The measurement circuit then applies the same open circuit bias VOC(A) as measured across the terminals of the first reference photosensor element across the terminals of the detection photosensor element.

(v) The measurement circuit then measures the current I_{P} that flows through the detection sensor element whilst VOC(A) is being applied across the terminals of the detection photosensor element.

(vi) The measurement circuit then measures the current I_{T}=I_{P}+I_{D}. The measured output representative of I_{T} is O_{T}.

The measured output O_{T} is then representative of the ambient light level.

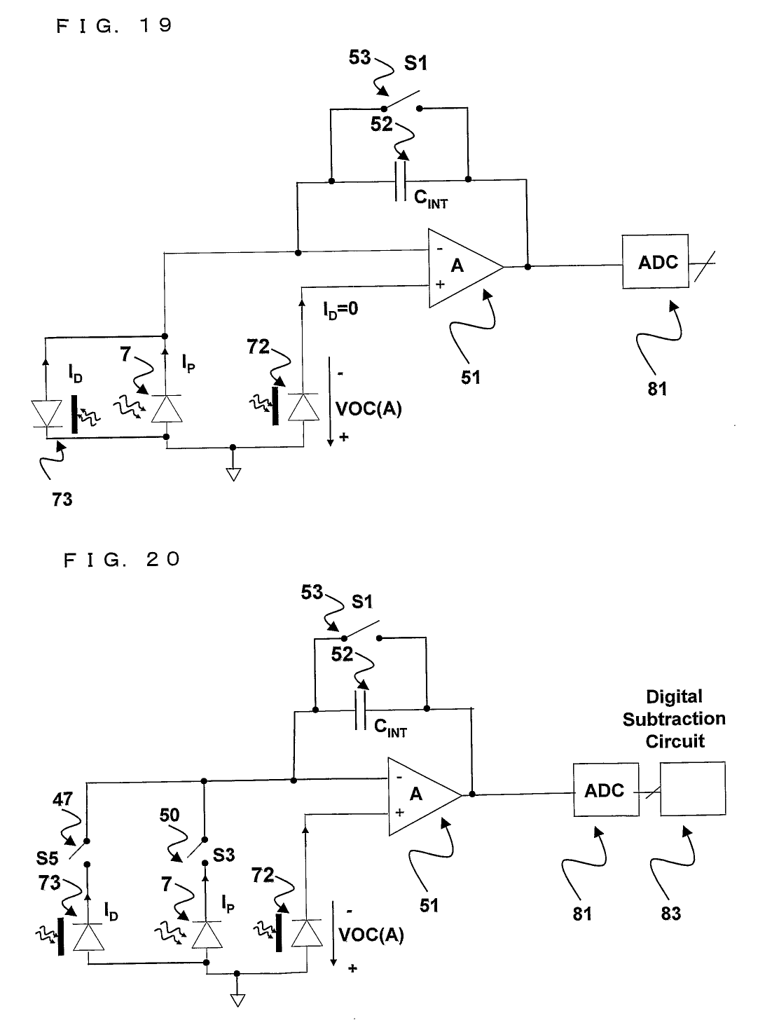

A practical example of a circuit for implementing this is shown in FIG. 19. This circuit contains the following elements:

A detection photodiode 7 which is exposed to ambient light

A first reference photodiode 72 which is shielded from ambient light.

A second reference photodiode 73 which is shielded from ambient light.

An operational amplifier 51 of standard construction.

An integration capacitor C_{INT} 52

A switch S1 53.

An Analogue to Digital Converter 81(ADC) circuit of standard construction.

The anode of the detection photodiode 7 is connected to the anode of the first reference photodiode 20 and to the cathode of the second reference photodiode 73 which is connected to ground. The cathode of the first reference photodiode 73 is connected to the non-inverting input of the operational amplifier 51. The cathode of the detection photodiode 7 is connected to the anode of the second reference photodiode 73 which is connected to the inverting input of the operational amplifier 51. The switch S1 53 is connected between the inverting input and the output of the operational amplifier. The integration capacitor 52 is connected between the inverting input and the output of the operational amplifier 51. The ADC 81 is connected to the output of the operational amplifier 51.

The operation of this circuit has three phases: (i) a reset phase, (ii) an integration phase and (iii) a readout phase. The detailed operation is as follows:

During the reset phase, the switch S1 53 is closed. This resets the potential across the integration capacitor C_{INT} to 0 Volts.

At the beginning of the integration period the switch S1 53 is opened.

Since the bias at the non-inverting terminal of the operational amplifier 51 is minus VOC(A), the operational amplifier 51 will work so as to maintain a bias also equal to VOC(A) at the non-inverting input terminal. Therefore a bias equal to VOC(A) will be maintained between the terminals of the detection photodiode 7. A bias equal to minus VOC(A) will be maintained between the terminals of the second reference photodiode 73.

During the integration period the detection photodiode will generate a current I_{P} and the second reference photodiode generates a current I_{D}. The sum of these current I_{T}=I_{P}+I_{D} is then integrated onto the integration capacitor C_{INT} 52 and measured during the readout phase as has already been described. The digital signal generated at the output of the ADC 81, denoted O_{T} is then representative of the ambient light level

It will be apparent to one who is skilled in the art that there are many possible alternative implementations of the schematic circuit of FIG. 19.

An advantage of the third embodiment is that it facilitates a second order correction as described in the second embodiment, whilst additionally only requiring one switch in the circuit.

The fourth embodiment consists of a light sensor circuit comprising of the following elements:

A detection photosensor element which is exposed to ambient light.

A reference photosensor element which is shielded from ambient light.

A second reference photosensor element which is shielded from ambient light.

A measurement circuit which is connected to the detection and reference photosensor elements.

A subtraction circuit for storing and subtracting two digital signals

The operation of the light sensor circuit of this embodiment is as follows:

(i) The measurement circuit measures the bias that needs to be applied between the two terminals of the first reference photosensor element such that a current substantially equal to zero flows through the first reference photosensor element. The bias that the measurement circuit needs to apply in order to achieve this is then substantially equal to the open circuit bias of the first reference photosensor element VOC(A).

(ii) The measurement circuit then applies the bias VOC(A) between the terminals of the second reference photosensor element and measures the current I_{D} that flows between the terminals of the second reference photosensor element under these bias conditions. The measured output representative of I_{D} is O_{D}.

(iii) The measurement circuit then applies the same open circuit bias VOC(A) as measured by the first reference photosensor element 72 across the terminals of the detection photosensor element.

(iv) The measurement circuit then measures the current I_{P} that flows through the detection sensor element whilst VOC(A) is being applied across the terminals of the detection photosensor element. The measured output representative of I_{P} is O_{P}.

(v) The subtraction circuit 48 then measures the difference in the two outputs O_{T}=O_{P}−O_{D}

The measured output O_{T} is then representative of the ambient light level.

A practical example of a circuit is shown in FIG. 20. This circuit contains the following elements:

A detection photodiode 7 which is exposed to ambient light

A first reference photodiode 72 which is shielded from ambient light.

A second reference photodiode 73 which is shielded from ambient light.

An operational amplifier 51 of standard construction.

An integration capacitor C_{INT} 52

A switch S1 53.

A switch S3 50

A switch S5 57

An Analogue to Digital Converter 81(ADC) circuit of standard construction

A digital subtraction circuit 83 of standard construction.

The anode of the detection photodiode 7 is connected to the anode of the first reference photodiode 72 and to the anode of the second reference photodiode 73 which is connected to ground. The cathode of the first reference photodiode 72 is connected to the non-inverting input of the operational amplifier 5. The cathode of the detection photodiode 7 is connected to the first terminal of switch S3. The anode of the second reference photodiode 73 is connected to the first terminal of switch S5. The second terminal of switch S3 is connected to the second terminal of switch S5 which is connected to the inverting input of the operational amplifier 51. The switch S1 53 is connected between the inverting input and the output of the operational amplifier 51. The integration capacitor 52 is connected between the inverting input and the output of the operational amplifier 51. The ADC 81 is connected to the output of the operational amplifier 51. The digital subtraction circuit 82 is connected to the output of the ADC 81.

The operation of this circuit has six phases: (i) a first reset phase, (ii) a first integration phase, (iii) a first readout phase, (iv) a second reset phase, (v) a second integration phase and (vi) a second readout phase. The detailed operation is as follows:

During the first reset phase, the switch S1 53 is closed and switches S3 and S5 are open. This resets the potential across the integration capacitor C_{INT} 52 to 0 Volts.

At the beginning of the first integration period the switch S1 53 is opened and switch S5 47 is closed.

Since the bias at the non-inverting terminal of the operational amplifier 51 is minus VOC(A), the operational amplifier will work so as to maintain a bias also equal to minus VOC(A) at the non-inverting input terminal. Therefore a bias equal to VOC(A) will be maintained between the terminals of the second reference photodiode 73.

During the first integration period the second reference photodiode 73 will generate a current I_{D} which is then integrated onto the integration capacitor C_{INT} 52 and measured during the first readout phase as has already been described. The digital signal generated at the output of the ADC 81, denoted O_{D}, is stored in the digital subtraction circuit 83.

The second reset period then commences, switches S3 and S5 are opened and switch S1 is closed. This resets the potential across the integration capacitor C_{INT} to 0 Volts.

At the beginning of the second integration period the switch S1 53 is opened and switch S3 50 is closed.

Since the bias at the non-inverting terminal of the operational amplifier 51 is minus VOC(A), the operational amplifier will work so as to maintain a bias also equal to minus VOC(A) at the non-inverting input terminal. Therefore a bias equal to VOC(A) will be maintained between the terminals of the detection photodiode 7.

During the second integration period the detection photodiode 7 will generate a current I_{P} which is then integrated onto the integration capacitor C_{INT} 52 and measured during the second readout phase as has already been described. The digital signal generated at the output of the ADC 81, denoted O_{P}, is stored in the digital subtraction circuit 83.

The two digital signals O_{P} and O_{D} are then subtracted by the digital subtraction circuit 83. The resulting digital signal O_{T} is then representative of the ambient light level.

It will be apparent to one who is skilled in the art that there are many possible alternative implementations of the schematic circuit of FIG. 20.

An advantage of the fourth embodiment is that it facilitates a second order correction as described in the second embodiment, whilst not requiring as many extra switches as the second embodiment, and whilst also not requiring the second reference photodiode to have a bias equal in magnitude but opposite in sign to the photodiode bias across its terminals (as is the case for the third embodiment).

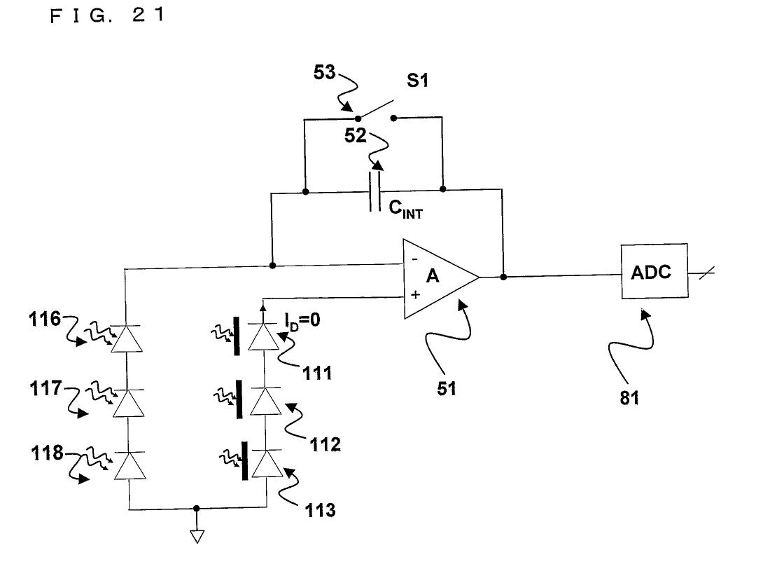

The fifth embodiment is shown in FIG. 21. This embodiment is as the first embodiment except that the detection photodiode has been replaced by three photodiodes arranged in series and the reference photodiode has been replaced by three reference photodiodes arranged in series. The circuit is connected as follows:

The anode of the first detection photodiode 118 is connected to the anode of the first reference photodiode 113 which is connected to ground. The anode of the second detection photodiode 117 is connected to the cathode of the first detection photodiode 118. The anode of the third detection photodiode 116 is connected to the cathode of the second detection photodiode 117. The cathode of the third detection photodiode 116 is connected to the inverting input of the operational amplifier 51. The anode of the second reference photodiode 112 is connected to the cathode of the first reference photodiode 113. The anode of the third reference photodiode 111 is connected to the cathode of the second reference photodiode 112. The cathode of the third reference photodiode 111 is connected to the non-inverting input of the operational amplifier 51. The switch S1 53 is connected between the inverting input and the output of the operational amplifier 51. The integration capacitor 52 is connected between the inverting input and the output of the operational amplifier 51. The ADC 81 is connected to the output of the opamp 51.

The operation of the circuit of FIG. 21 is then exactly as has already been described for the first embodiment.

It will be readily apparent to one skilled in the art that many variations on this embodiment are possible with any number of 2 or greater of detection photodiodes in series and with the same number of reference photodiodes in series.

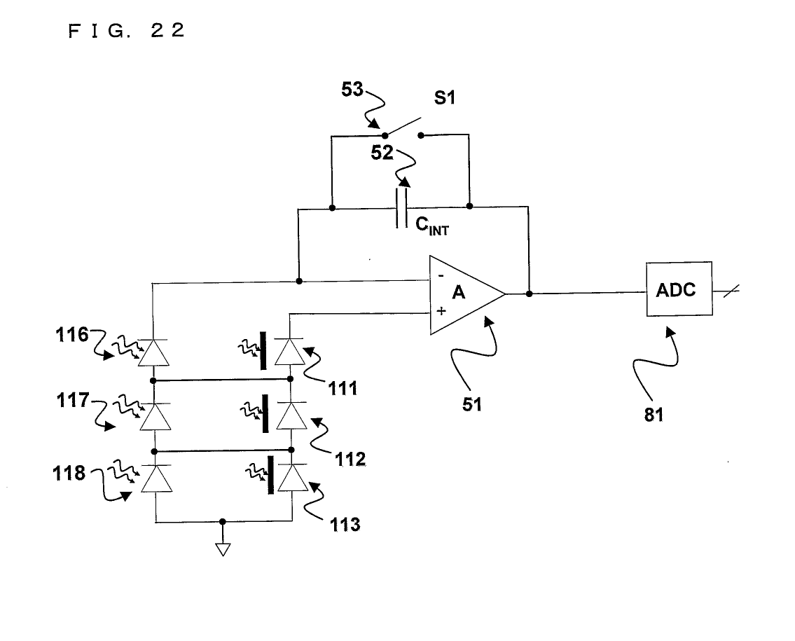

The sixth embodiment is shown in FIG. 22. This embodiment is as the fifth embodiment except that additional connections have been made between the terminals of detection and reference photodiodes. The circuit is connected as follows:

The anode of the first detection photodiode 118 is connected to the anode of the first reference photodiode 113 which is connected to ground. The anode of the second detection photodiode 117 is connected to the cathode of the first detection photodiode 118 and to the cathode of the first reference photodiode 113 and to the anode of the second reference photodiode 112. The anode of the third detection photodiode 116 is connected to the cathode of the second detection photodiode 117 and to the cathode of the second reference photodiode 112 and to the anode of the third reference photodiode 111. The cathode of the third detection photodiode 116 is connected to the inverting input of the operational amplifier 51. The cathode of the third reference photodiode 111 is connected to the non-inverting input of the operational amplifier 51. The switch S1 53 is connected between the inverting input and the output of the operational amplifier 51. The integration capacitor 52 is connected between the inverting input and the output of the operational amplifier 51. The ADC 81 is connected to the output of the opamp 51.

The operation of the circuit of FIG. 22 is then exactly as has already been described for the first embodiment. An advantage is that the extra connections between the photodiodes in this embodiment may facilitate better performance in the case where the photodiode elements are not perfectly matched.

It will be readily apparent to one skilled in the art that many variations on this embodiment are possible with any number of 2 or greater of detection photodiodes in series and with the same number of reference photodiodes in series.

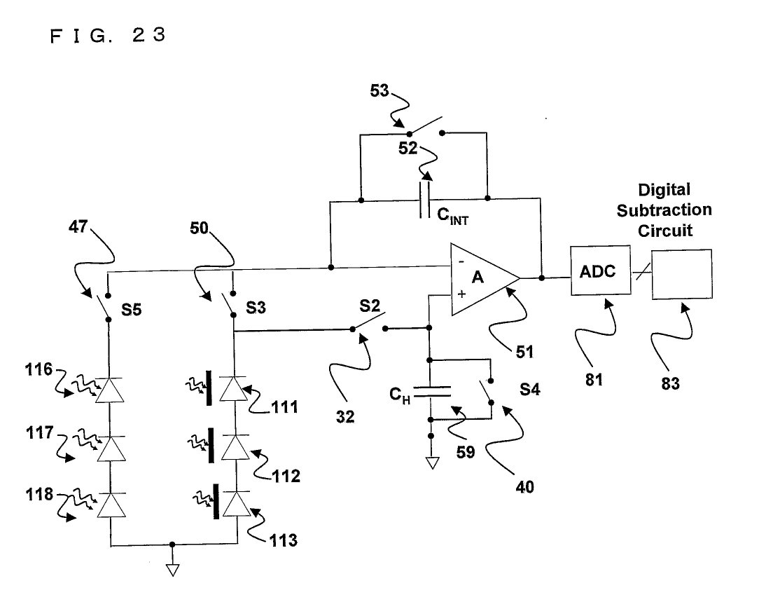

The seventh embodiment is shown in FIG. 23. This embodiment is as the second embodiment except that the detection photodiode has been replaced by three photodiodes arranged in series and the reference photodiode has been replaced by three reference photodiodes arranged in series. The circuit is connected as follows:

The anode of the first detection photodiode 118 is connected to the anode of the first reference photodiode 113 which is connected to ground. The anode of the second detection photodiode 117 is connected to the cathode of the first detection photodiode 118. The anode of the third detection photodiode 116 is connected to the cathode of the second detection photodiode 117. The anode of the second reference photodiode 112 is connected to the cathode of the first reference photodiode 113. The anode of the third reference photodiode 111 is connected to the cathode of the second reference photodiode 112. The cathode of the third reference photodiode 111 is connected to the first terminal of the switch S2 32. The second terminal of switch S2 32 is connected to the non-inverting input of the operational amplifier 51. The holding capacitor 59 is connected between the non-inverting input of the operational amplifier 51 and ground. The switch S4 40 is connected between the non-inverting input of the operational amplifier 51 and ground. The cathode of the third detection photodiode 116 is connected to the first terminal of the switch S5 47. The second terminal of the switch S5 47 is connected to the inverting input of the operational amplifier 51. The switch S1 53 is connected between the inverting input and the output of the operational amplifier 51. The integration capacitor 52 is connected between the inverting input and the output of the operational amplifier 51. The switch S3 50 is connected between the cathode of the reference photodiode 20 and the inverting input of the operational amplifier 51. The ADC 81 is connected to the output of the operational amplifier 51. The digital subtraction circuit 83 is connected to the output of the ADC 81.

The operation of the circuit of FIG. 23 is then exactly as has already been described for the first embodiment.

It will be readily apparent to one skilled in the art that many variations on this embodiment are possible with any number of 2 or greater of detection photodiodes in series and with the same number of reference photodiodes in series.

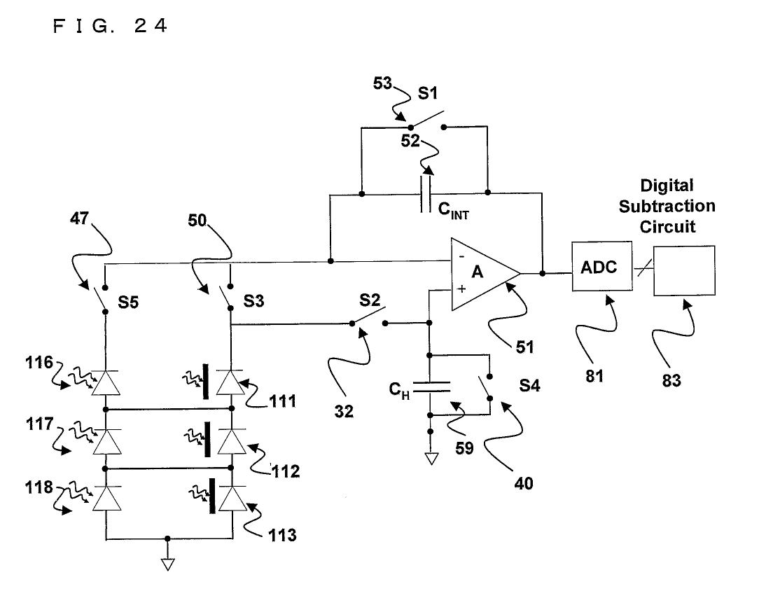

The eighth embodiment is shown in FIG. 24. This embodiment is as the seventh embodiment except that additional connections have been made between the terminals of detection and reference photodiodes. The circuit is connected as follows:

The anode of the first detection photodiode 118 is connected to the anode of the first reference photodiode 113 which is connected to ground. The anode of the second detection photodiode 117 is connected to the cathode of the first detection photodiode 118 and to the cathode of the first reference photodiode 113 and to the anode of the second reference photodiode 112. The anode of the third detection photodiode 116 is connected to the cathode of the second detection photodiode 117 and to the cathode of the second reference photodiode 112 and to the anode of the third reference photodiode 111. The cathode of the third reference photodiode 111 is connected to the first terminal of the switch S2 32. The second terminal of switch S2 32 is connected to the non-inverting input of the operational amplifier 51. The holding capacitor 59 is connected between the non-inverting input of the operational amplifier 51 and ground. The switch S4 40 is connected between the non-inverting input of the operational amplifier 51 and ground. The cathode of the third detection photodiode 116 is connected to the first terminal of the switch S5 47. The second terminal of the switch S5 47 is connected to the inverting input of the operational amplifier 51. The switch S1 53 is connected between the inverting input and the output of the operational amplifier 51. The integration capacitor 52 is connected between the inverting input and the output of the operational amplifier 51. The switch S3 50 is connected between the cathode of the reference photodiode 20 and the inverting input of the operational amplifier 51. The ADC 81 is connected to the output of the operational amplifier 51. The digital subtraction circuit 83 is connected to the output of the ADC 81.

The operation of the circuit of FIG. 24 is then exactly as has already been described for the second embodiment.

It will be readily apparent to one skilled in the art that many variations on this embodiment are possible with any number of 2 or greater of detection photodiodes in series and with the same number of reference photodiodes in series.

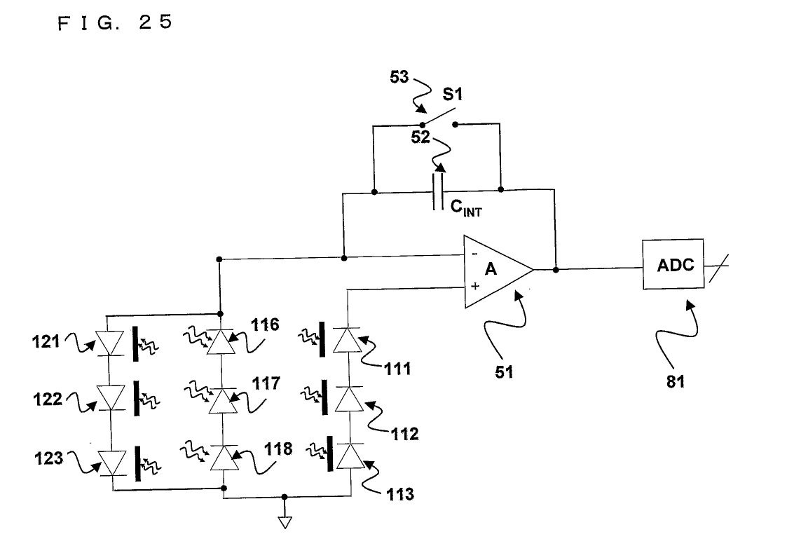

The ninth embodiment is shown in FIG. 25. This embodiment is as the third embodiment except that the detection photodiode has been replaced by three detection photodiodes arranged in series and the first reference photodiode has been replaced by three reference photodiodes arranged in series and the second reference photodiode has been replaced by three reference photodiodes arranged in series. The circuit is connected as follows:

The anode of the first detection photodiode 118 is connected to the anode of the first reference photodiode 113 which is connected to ground. The anode of the second detection photodiode 117 is connected to the cathode of the first detection photodiode 118. The anode of the third detection photodiode 116 is connected to the cathode of the second detection photodiode 117. The anode of the second reference photodiode 112 is connected to the cathode of the first reference photodiode 113. The anode of the third reference photodiode 111 is connected to the cathode of the second reference photodiode 112.

The cathode of the sixth reference photodiode 123 is connected to ground. The anode of the sixth reference photodiode 123 is connected to the cathode of the fifth reference photodiode 122. The anode of the fifth reference photodiode 122 is connected to the cathode of the fourth reference photodiode 121.

The cathode of the third reference photodiode 111 is connected to the non-inverting input of the operational amplifier 51. The cathode of the third detection photodiode 116 is connected to the anode of the fourth reference photodiode 121 which is connected to the inverting input of the operational amplifier 51. The switch S1 53 is connected between the inverting input and the output of the operational amplifier. The integration capacitor 52 is connected between the inverting input and the output of the operational amplifier 51. The ADC 81 is connected to the output of the operational amplifier 51.

The operation of the circuit of FIG. 25 is then exactly as has already been described for the third embodiment.

It will be readily apparent to one skilled in the art that many variations on this embodiment are possible with any number of 2 or greater of detection photodiodes in series and with the same number of reference photodiodes in series.

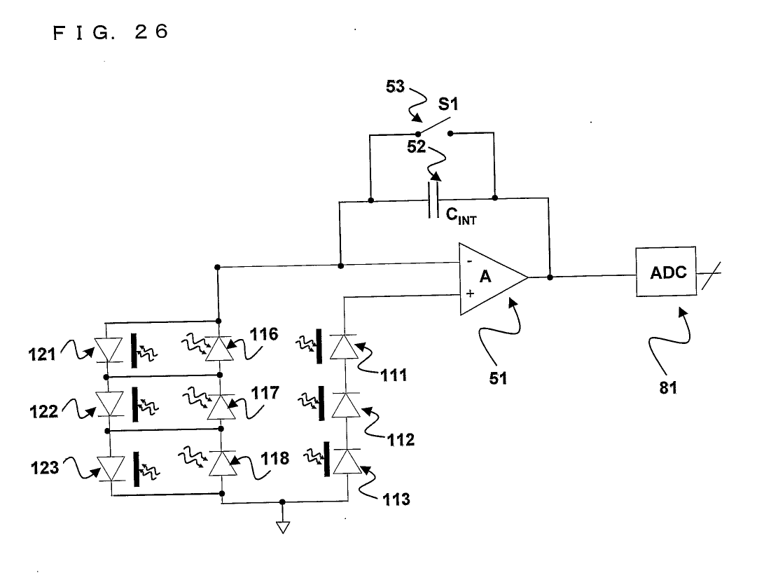

The tenth embodiment is shown in FIG. 26. This embodiment is as the ninth embodiment except that additional connections have been made between the terminals of detection and reference photodiodes. The circuit is connected as follows:

The anode of the first detection photodiode 118 is connected to the anode of the first reference photodiode 113 which is connected to the cathode of the sixth reference photodiode 123 which is connected to ground. The anode of the second detection photodiode 117 is connected to the cathode of the first detection photodiode 118 which is connected to the anode of the sixth reference photodiode 123 with is connected to the cathode of the fifth reference photodiode 122. The anode of the third detection photodiode 116 is connected to the cathode of the second detection photodiode 117 which is connected to the anode of the fifth reference photodiode 122 which is connected to the cathode of the fourth reference photodiode 121. The anode of the second reference photodiode 112 is connected to the cathode of the first reference photodiode 113. The anode of the third reference photodiode 111 is connected to the cathode of the second reference photodiode 112.

The cathode of the third reference photodiode 111 is connected to the non-inverting input of the operational amplifier 51. The cathode of the third detection photodiode 116 is connected to the anode of the fourth reference photodiode 121 which is connected to the inverting input of the operational amplifier 51. The switch S1 53 is connected between the inverting input and the output of the operational amplifier. The integration capacitor 52 is connected between the inverting input and the output of the operational amplifier 51. The ADC 81 is connected to the output of the operational amplifier 51.

The operation of the circuit of FIG. 26 is then exactly as has already been described for the third embodiment.

It will be readily apparent to one skilled in the art that many variations on this embodiment are possible with any number of 2 or greater of detection photodiodes in series and with the same number of reference photodiodes in series.

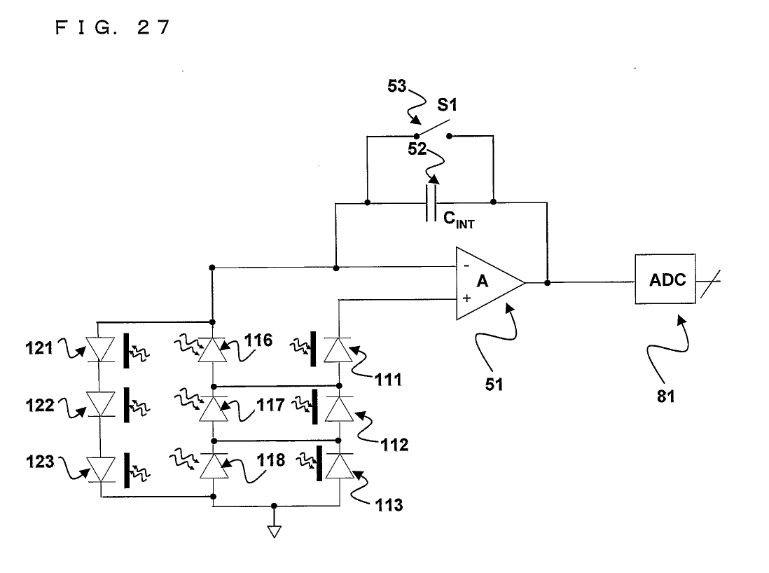

The eleventh embodiment is shown in FIG. 27. This embodiment is as the ninth embodiment except that additional connections have been made between the terminals of detection and reference photodiodes. The circuit is connected as follows:

The anode of the first detection photodiode 118 is connected to the anode of the first reference photodiode 113 which is connected to the cathode of the sixth reference photodiode 123 which is connected to ground. The anode of the second detection photodiode 117 is connected to the cathode of the first detection photodiode 118 which is connected to the anode of the second reference photodiode 112 with is connected to the cathode of the first reference photodiode 113. The anode of the third detection photodiode 116 is connected to the cathode of the second detection photodiode 117 which is connected to the anode of the third reference photodiode 111 which is connected to the cathode of the second reference photodiode 112. The anode of the sixth reference photodiode 123 is connected to the cathode of the fifth reference photodiode 122. The anode of the fourth reference photodiode 121 is connected to the cathode of the fifth reference photodiode 122.

The cathode of the third reference photodiode 111 is connected to the non-inverting input of the operational amplifier 51. The cathode of the third detection photodiode 116 is connected to the anode of the fourth reference photodiode 121 which is connected to the inverting input of the operational amplifier 51. The switch S1 53 is connected between the inverting input and the output of the operational amplifier. The integration capacitor 52 is connected between the inverting input and the output of the operational amplifier 51. The ADC 81 is connected to the output of the operational amplifier 51.

The operation of the circuit of FIG. 27 is then exactly as has already been described for the third embodiment.

It will be readily apparent to one skilled in the art that many variations on this embodiment are possible with any number of 2 or greater of detection photodiodes in series and with the same number of reference photodiodes in series.

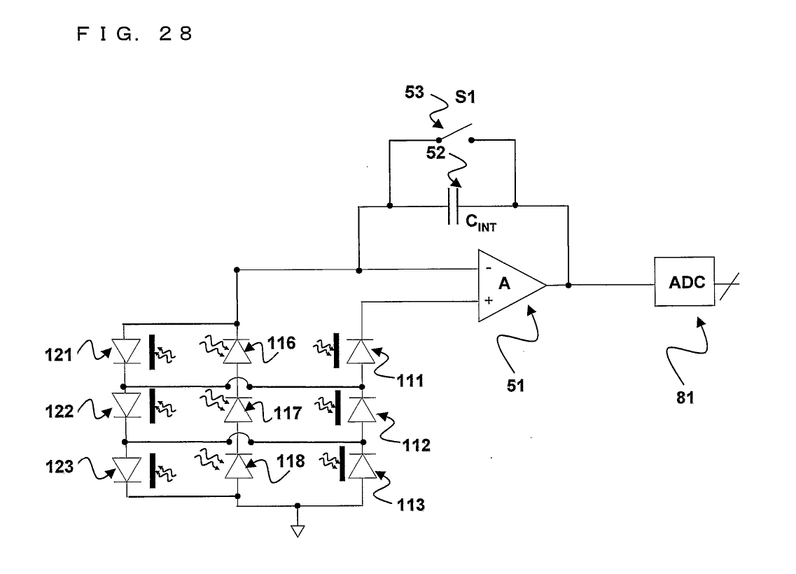

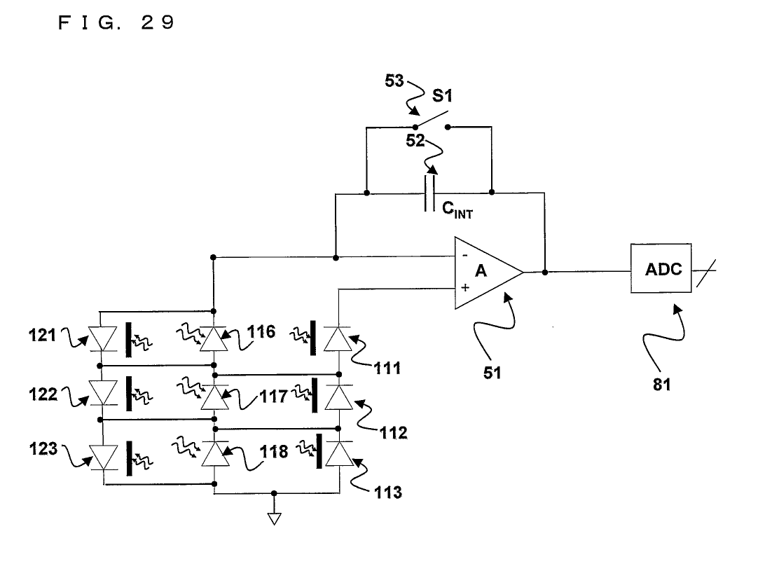

The twelfth embodiment is shown in FIG. 28. This embodiment is as the ninth embodiment except that additional connections have been made between the terminals of detection and reference photodiodes. The circuit is connected as follows:

The anode of the first detection photodiode 118 is connected to the anode of the first reference photodiode 113 which is connected to the cathode of the sixth reference photodiode 123 which is connected to ground.

The anode of the second detection photodiode 117 is connected to the cathode of the first detection photodiode 118. The anode of the third detection photodiode 116 is connected to the cathode of the second detection photodiode 117.

The cathode of the first reference photodiode 113 is connected to the anode of the second reference photodiode 112 which is connected to the anode of the sixth reference photodiode 123 which is connected to the cathode of the fifth reference photodiode 122. The cathode of the second reference photodiode 112 is connected to the anode of the third reference photodiode 111 which is connected to the anode of the fifth reference photodiode 122 which is connected to the cathode of the fourth reference photodiode 121.

The cathode of the third reference photodiode 111 is connected to the non-inverting input of the operational amplifier 51. The cathode of the third detection photodiode 116 is connected to the anode of the fourth reference photodiode 121 which is connected to the inverting input of the operational amplifier 51. The switch S1 53 is connected between the inverting input and the output of the operational amplifier. The integration capacitor 52 is connected between the inverting input and the output of the operational amplifier 51. The ADC 81 is connected to the output of the operational amplifier 51.

The operation of the circuit of FIG. 28 is then exactly as has already been described for the third embodiment.

It will be readily apparent to one skilled in the art that many variations on this embodiment are possible with any number of 2 or greater of detection photodiodes in series and with the same number of reference photodiodes in series.

The thirteenth embodiment is shown in FIG. 29. This embodiment is as the ninth embodiment except that additional connections have been made between the terminals of detection and reference photodiodes. The circuit is connected as follows:

The anode of the first detection photodiode 118 is connected to the anode of the first reference photodiode 113 which is connected to the cathode of the sixth reference photodiode 123 which is connected to ground.

The cathode of the first reference photodiode 113 is connected to the cathode of the first detection photodiode 118 which is connected to the anode of the second detection photodiode which is connected to the anode of the second reference photodiode 112 which is connected to the anode of the sixth reference photodiode 123 which is connected to the cathode of the fifth reference photodiode 122. The cathode of the second reference photodiode 112 is connected to the anode of the third reference photodiode 111 which is connected to the cathode of the second detection photodiode 117 which is connected to the anode of the third detection photodiode 116 which is connected to the anode of the fifth reference photodiode 122 which is connected to the cathode of the fourth reference photodiode 121.

The cathode of the third reference photodiode 111 is connected to the non-inverting input of the operational amplifier 51. The cathode of the third detection photodiode 116 is connected to the anode of the fourth reference photodiode 121 which is connected to the inverting input of the operational amplifier 51. The switch S1 53 is connected between the inverting input and the output of the operational amplifier. The integration capacitor 52 is connected between the inverting input and the output of the operational amplifier 51. The ADC 81 is connected to the output of the operational amplifier 51.

The operation of the circuit of FIG. 29 is then exactly as has already been described for the third embodiment.

It will be readily apparent to one skilled in the art that many variations on this embodiment are possible with any number of 2 or greater of detection photodiodes in series and with the same number of reference photodiodes in series.

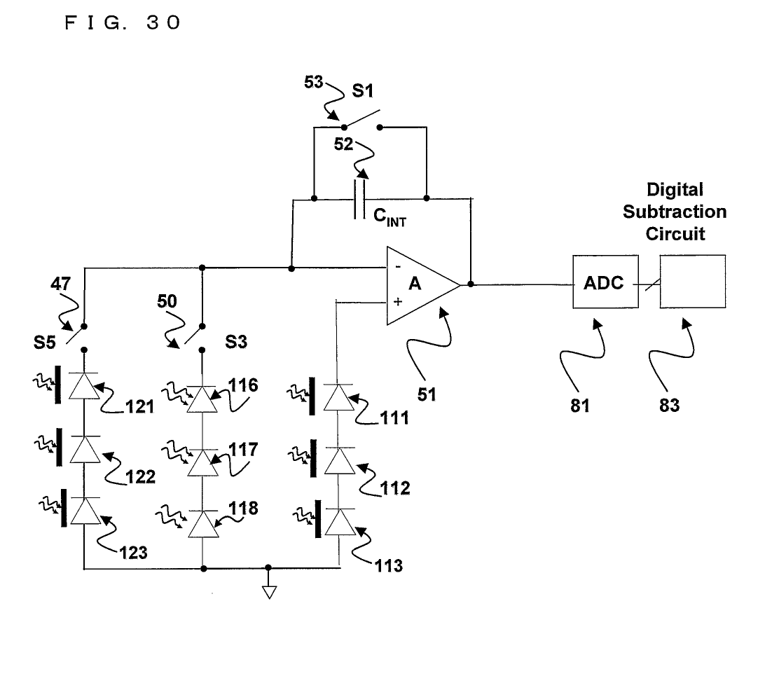

The fourteenth embodiment is shown in FIG. 30. This embodiment is as the fourth embodiment except that the detection photodiode has been replaced by three photodiodes arranged in series and the first reference photodiode has been replaced by three reference photodiodes arranged in series and the second reference photodiode has been replaced by three reference photodiodes arranged in series. The circuit is connected as follows:

The anode of the first detection photodiode 118 is connected to the anode of the first reference photodiode 113 which is connected to the anode of the fourth reference photodiode 123 which is connected to ground. The anode of the second detection photodiode 117 is connected to the cathode of the first detection photodiode 118. The anode of the third detection photodiode 116 is connected to the cathode of the second detection photodiode 117. The anode of the second reference photodiode 112 is connected to the cathode of the first reference photodiode 113. The anode of the third reference photodiode 111 is connected to the cathode of the second reference photodiode 112.

The anode of the fifth reference photodiode 122 is connected to the cathode of the fourth reference photodiode 123. The anode of the sixth reference photodiode 123 is connected to the cathode of the fifth reference photodiode 122.

The cathode of the third detection photodiode 116 is connected to the first terminal of switch S3. The cathode of the sixth reference photodiode is connected to the first terminal of switch S5. The second terminal of switch S5 is connected to the second terminal of switch S3 which is connected to the inverting input of the operational amplifier 5. The cathode of the third reference photodiode 111 is connected to the non inverting input of the operational amplifier 51. The switch S1 53 is connected between the inverting input and the output of the operational amplifier 51. The integration capacitor 52 is connected between the inverting input and the output of the operational amplifier 51. The ADC 81 is connected to the output of the operational amplifier 51. The digital subtraction circuit 82 is connected to the output of the ADC 81.

The operation of the circuit of FIG. 30 is then exactly as has already been described for the fourth embodiment.

It will be readily apparent to one skilled in the art that many variations on this embodiment are possible with any number of 2 or greater of detection photodiodes in series and with the same number of reference photodiodes in series.

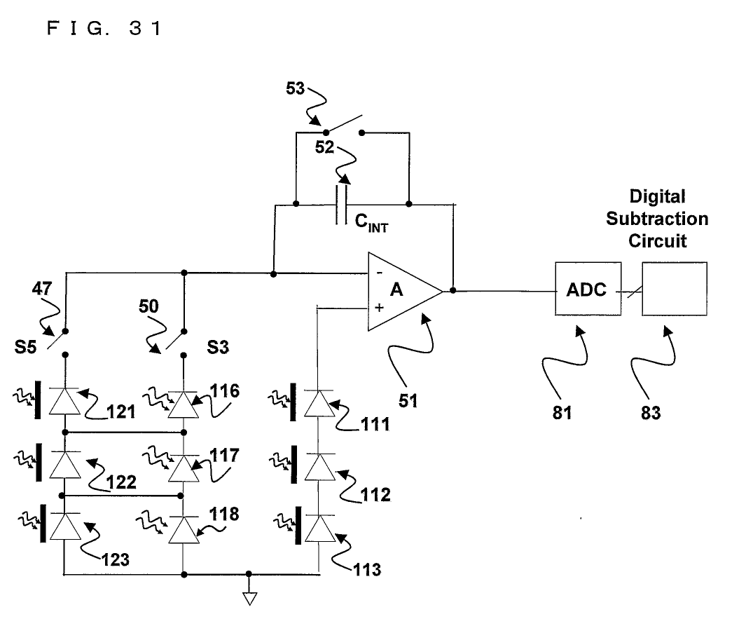

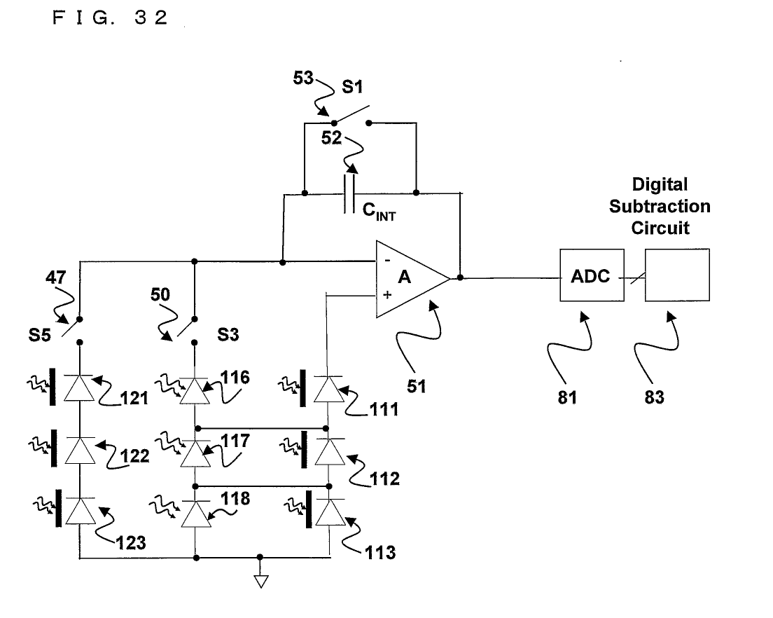

The fifteenth embodiment is shown in FIG. 31. This embodiment is as the fourteenth embodiment except that additional connections have been made between the terminals of detection and reference photodiodes. The circuit is connected as follows:

The anode of the first detection photodiode 118 is connected to the anode of the first reference photodiode 113 which is connected to the anode of the fourth reference photodiode 123 which is connected to ground. The anode of the second detection photodiode 117 is connected to the cathode of the first detection photodiode 118 which is connected to the cathode of the fourth reference photodiode 123 which is connected to the anode of the fifth reference photodiode 122. The anode of the third detection photodiode 116 is connected to the cathode of the second detection photodiode 117 which is connected to the cathode of the fifth reference photodiode 122 which is connected to the anode of the sixth reference photodiode 121. The anode of the second reference photodiode 112 is connected to the cathode of the first reference photodiode 113. The anode of the third reference photodiode 111 is connected to the cathode of the second reference photodiode 112.

The cathode of the third detection photodiode 116 is connected to the first terminal of switch S3. The cathode of the sixth reference photodiode is connected to the first terminal of switch S5. The second terminal of switch S5 is connected to the second terminal of switch S3 which is connected to the inverting input of the operational amplifier 5. The cathode of the third reference photodiode 111 is connected to the non inverting input of the operational amplifier 51. The switch S1 53 is connected between the inverting input and the output of the operational amplifier 51. The integration capacitor 52 is connected between the inverting input and the output of the operational amplifier 51. The ADC 81 is connected to the output of the operational amplifier 51. The digital subtraction circuit 82 is connected to the output of the ADC 81.

The operation of the circuit of FIG. 31 is then exactly as has already been described for the fourth embodiment.

It will be readily apparent to one skilled in the art that many variations on this embodiment are possible with any number of 2 or greater of detection photodiodes in series and with the same number of reference photodiodes in series.

The sixteenth embodiment is shown in FIG. 32. This embodiment is as the fourteenth embodiment except that additional connections have been made between the terminals of detection and reference photodiodes. The circuit is connected as follows:

The anode of the first detection photodiode 118 is connected to the anode of the first reference photodiode 113 which is connected to the anode of the fourth reference photodiode 123 which is connected to ground. The anode of the second detection photodiode 117 is connected to the cathode of the first detection photodiode 118 which is connected to the cathode of the first reference photodiode 113 which is connected to the anode of the second reference photodiode 112. The anode of the third detection photodiode 116 is connected to the cathode of the second detection photodiode 117 which is connected to the cathode of the second reference photodiode 112 which is connected to the anode of the third reference photodiode 111. The anode of the fifth reference photodiode 122 is connected to the cathode of the fourth reference photodiode 123. The anode of the sixth reference photodiode 121 is connected to the cathode of the second reference photodiode 122.

The cathode of the third detection photodiode 116 is connected to the first terminal of switch S3. The cathode of the sixth reference photodiode is connected to the first terminal of switch S5. The second terminal of switch S5 is connected to the second terminal of switch S3 which is connected to the inverting input of the operational amplifier 5. The cathode of the third reference photodiode 111 is connected to the non inverting input of the operational amplifier 51. The switch S1 53 is connected between the inverting input and the output of the operational amplifier 51. The integration capacitor 52 is connected between the inverting input and the output of the operational amplifier 51. The ADC 81 is connected to the output of the operational amplifier 51. The digital subtraction circuit 82 is connected to the output of the ADC 81.

The operation of the circuit of FIG. 32 is then exactly as has already been described for the fourth embodiment.

It will be readily apparent to one skilled in the art that many variations on this embodiment are possible with any number of 2 or greater of detection photodiodes in series and with the same number of reference photodiodes in series.

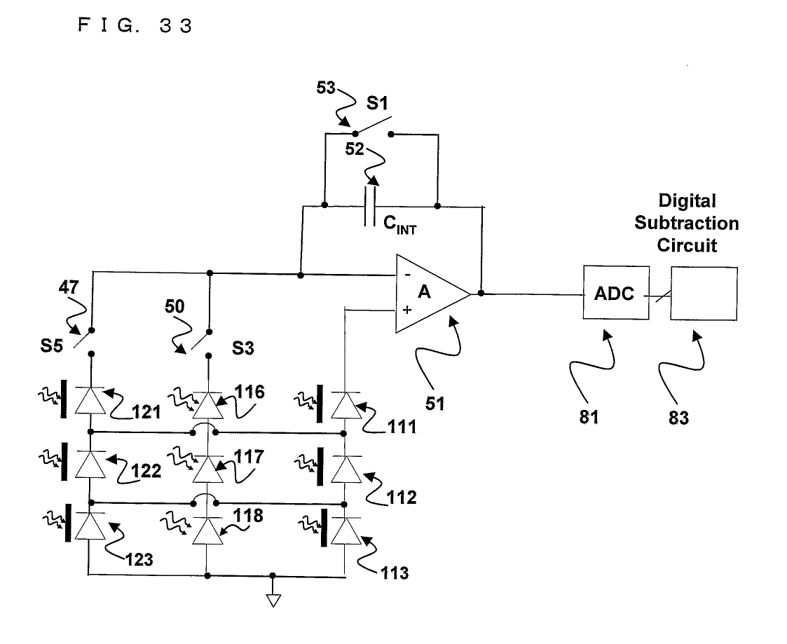

The seventeenth embodiment is shown in FIG. 33. This embodiment is as the fourteenth embodiment except that additional connections have been made between the terminals of detection and reference photodiodes. The circuit is connected as follows:

The anode of the first detection photodiode 118 is connected to the anode of the first reference photodiode 113 which is connected to the anode of the fourth reference photodiode 123 which is connected to ground. The anode of the second reference photodiode 122 is connected to the cathode of the first reference photodiode 123 which is connected to the cathode of the fourth reference photodiode 123 which is connected to the anode of the fifth reference photodiode 122. The anode of the third reference photodiode 111 is connected to the cathode of the second reference photodiode 112 which is connected to the cathode of the fifth reference photodiode 122 which is connected to the anode of the sixth reference photodiode 121. The anode of the second detection photodiode 117 is connected to the cathode of the first detection photodiode 118. The anode of the third detection photodiode 1116 is connected to the cathode of the second detection photodiode 127.

The cathode of the third detection photodiode 116 is connected to the first terminal of switch S3: The cathode of the sixth reference photodiode is connected to the first terminal of switch S5. The second terminal of switch S5 is connected to the second terminal of switch S3 which is connected to the inverting input of the operational amplifier 5. The cathode of the third reference photodiode 111 is connected to the non inverting input of the operational amplifier 51. The switch S1 53 is connected between the inverting input and the output of the operational amplifier 51. The integration capacitor 52 is connected between the inverting input and the output of the operational amplifier 51. The ADC 81 is connected to the output of the operational amplifier 51. The digital subtraction circuit 82 is connected to the output of the ADC 81.

The operation of the circuit of FIG. 33 is then exactly as has already been described for the fourth embodiment.

It will be readily apparent to one skilled in the art that many variations on this embodiment are possible with any number of 2 or greater of detection photodiodes in series and with the same number of reference photodiodes in series.

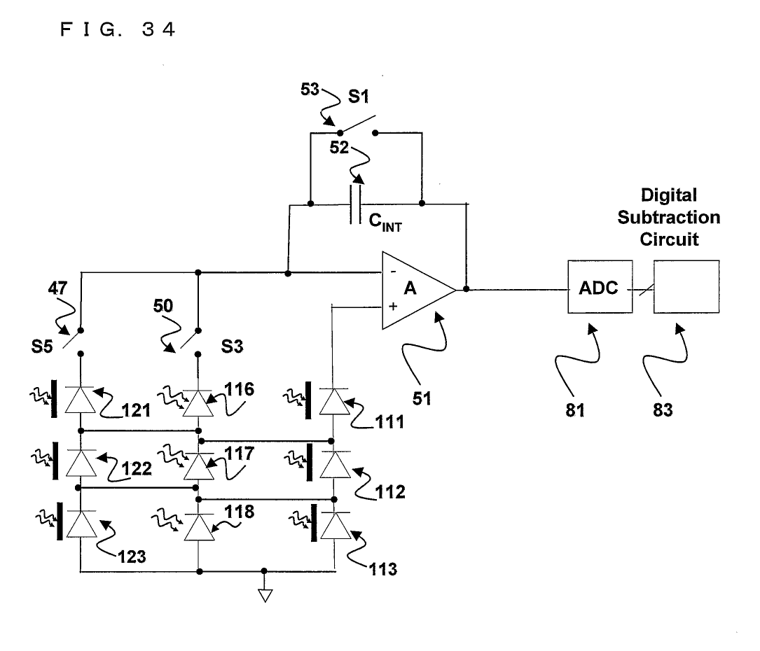

The eighteenth embodiment is shown in FIG. 34. This embodiment is as the fourteenth embodiment except that additional connections have been made between the terminals of detection and reference photodiodes. The circuit is connected as follows:

The anode of the first detection photodiode 118 is connected to the anode of the first reference photodiode 113 which is connected to the anode of the fourth reference photodiode 123 which is connected to ground. The anode of the second reference photodiode 112 is connected to the cathode of the first reference photodiode 113 which is connected to the cathode of the fourth reference photodiode 123 which is connected to the anode of the fifth reference photodiode 122 which is connected to the anode of the second detection photodiode 117 which is connected to the cathode of the first detection photodiode 118. The anode of the third reference photodiode 111 is connected to the cathode of the second reference photodiode 112 which is connected to the cathode of the fifth reference photodiode 122 which is connected to the anode of the sixth reference photodiode 121 which is connected to the anode of the third detection photodiode 116 which is connected to the cathode of the second detection photodiode 117.

The cathode of the third detection photodiode 116 is connected to the first terminal of switch S3. The cathode of the sixth reference photodiode is connected to the first terminal of switch S5. The second terminal of switch S5 is connected to the second terminal of switch S3 which is connected to the inverting input of the operational amplifier 5. The cathode of the third reference photodiode 111 is connected to the non inverting input of the operational amplifier 51. The switch S1 53 is connected between the inverting input and the output of the operational amplifier 51. The integration capacitor 52 is connected between the inverting input and the output of the operational amplifier 51. The ADC 81 is connected to the output of the operational amplifier 51. The digital subtraction circuit 82 is connected to the output of the ADC 81.

The operation of the circuit of FIG. 34 is then exactly as has already been described for the fourth embodiment.

It will be readily apparent to one skilled in the art that many variations on this embodiment are possible with any number of 2 or greater of detection photodiodes in series and with the same number of reference photodiodes in series.

An advantage of the fifth to eighteenth embodiments is that by using multiple photodiodes connected in series the requirements for precision biasing of the circuit as eased as previously described.

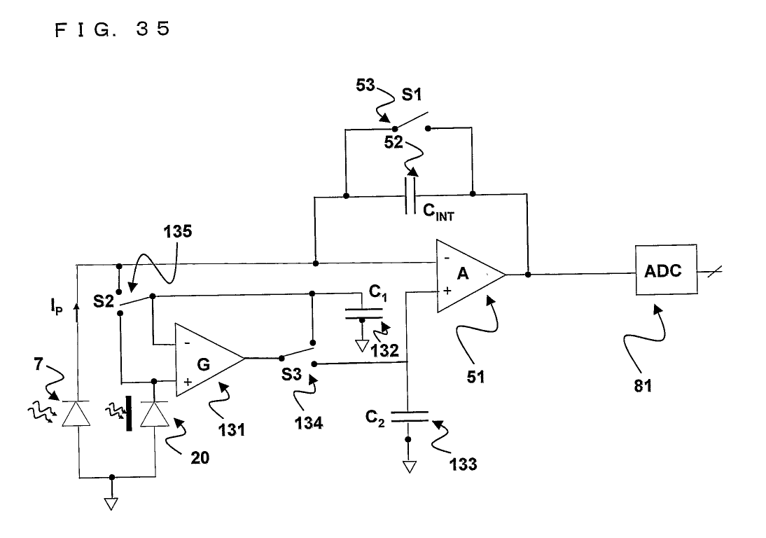

The nineteenth embodiment of the circuit is shown in FIG. 35.

This circuit contains the following elements:

A detection photodiode 7 which is exposed to ambient light

A first reference photodiode 72 which is shielded from ambient light.

An operational amplifier 51 of standard construction.

A second operational amplifier 131

A first STDP switch S2 135

A second STDP switch S3 134

An integration capacitor C_{INT} 52

A switch S1 53.

A capacitor C1 132

A capacitor C2 133

An Analogue to Digital Converter 81(ADC) circuit of standard construction

The circuit is connected as follows:

The anode of the detection photodiode 7 is connected to the anode of the reference photodiode 20 which is connected to ground. The cathode of the detection photodiode 7 is connected to the inverting input of the operational amplifier 51. The cathode of the reference photodiode 20 is connected to the non-inverting input of the second operational amplifier 131. The capacitor C1 132 is connected between the inverting input of the second operational amplifier 131 and ground. The capacitor C2 133 is connected between ground and the inverting input of the first operational amplifier 51. The switch S2 135 is connected so that the first pole connects the non-inverting input of the second operational amplifier 131 with the inverting input of the same operational amplifier 131 and the second pole connects the inverting input of the second operational amplifier 131 to the inverting input of the first operational amplifier 51. Switch S3 134 is connected so that the first pole connects the output of the second operational amplifier 131 with the non-inverting input of the first operational amplifier 51 and the second pole connects the output of the second operational amplifier 131 with the inverting input of the second operational amplifier. The switch S1 53 is connected between the inverting input and the output of the operational amplifier 51. The integration capacitor 52 is connected between the inverting input and the output of the operational amplifier 51. The ADC 81 is connected to the output of the operational amplifier 51. The digital subtraction circuit 82 is connected to the output of the ADC 81.

The operation of the circuit is as follows:

In the first phase of operation switch S3 is set in the upper position and switch S2 in the lower position as represented in FIG. 35. Under these conditions the second operational amplifier 131 is auto zeroed and a potential equal to the offset voltage of the second operational 131 plus the open circuit voltage of the reference photodiode 20 VOC(A) is generated across the terminals of capacitor C1 132.

In the second phase of operation, switch S3 is set in the lower position and switch S2 in the upper position. The offset of the operational amplifier 51 plus minus the open circuit voltage VOC(A) is then sampled and held on capacitor C2 whilst the nulling amplifier 131 is zeroing its own offset.

The switch S1 is then closed so that the photocurrent I_{P} is integrated, in exactly the same way as has already been described for the first embodiment. The digital output O_{P} at the output of the ADC 81 is then representative of the ambient light level.

An advantage of using the feed-forward technique is that the low offset nulling amplifier 131 can be used to sense any offset voltage of the operational amplifier 51 and generate a correction voltage that is then applied to the non inverting input of the operational amplifier 51 to cancel its own offset.

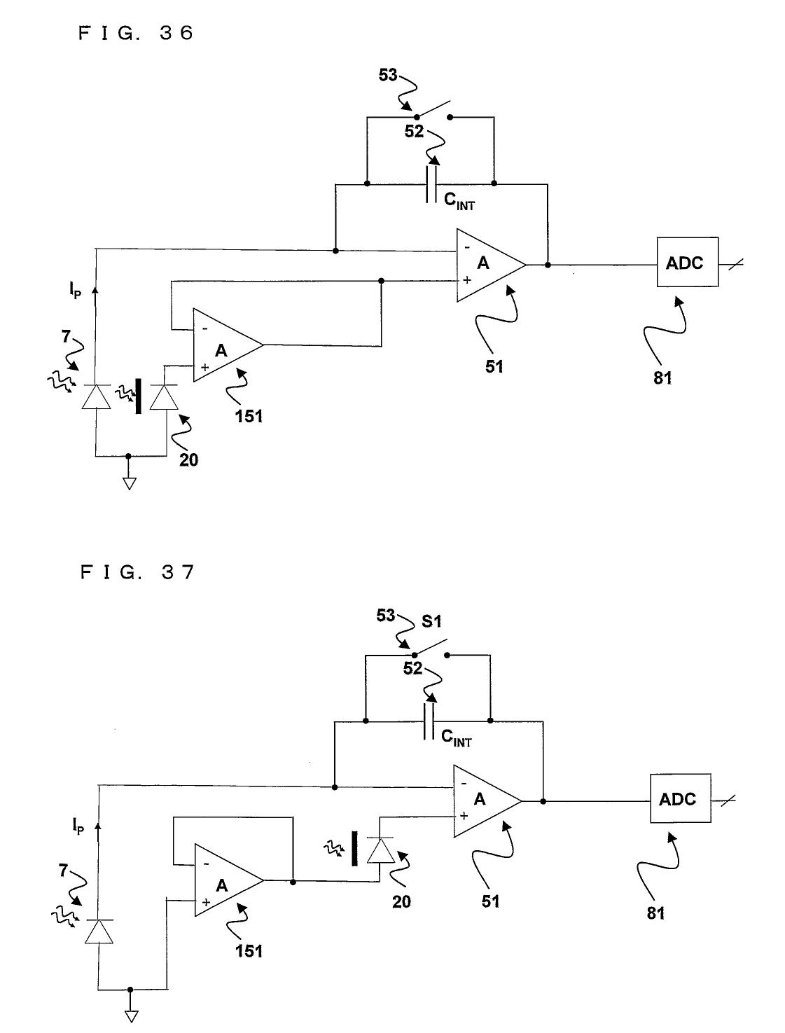

The twentieth embodiment is shown in FIG. 36.

This circuit contains the following elements:

A detection photodiode 7 which is exposed to ambient light

A first reference photodiode 72 which is shielded from ambient light.

An operational amplifier 51 of standard construction.

A second operational amplifier 151

An integration capacitor C_{INT} 52

A switch S1 53.

An Analogue to Digital Converter 81(ADC) circuit of standard construction

The circuit is connected as follows:

The anode of the detection photodiode 7 is connected to the anode of the reference photodiode 20 which is connected to ground. The cathode of the detection photodiode 7 is connected to the inverting input of the operational amplifier 51. The cathode of the reference photodiode 20 is connected to the non-inverting input of the second operational amplifier 151. The inverting input of the second operational amplifier 151 is connected to the output of the second operational amplifier 151 which is connected to the non-inverting input of the first operational amplifier 51.

The switch S1 53 is connected between the inverting input and the output of the operational amplifier 51. The integration capacitor 52 is connected between the inverting input and the output of the operational amplifier 51. The ADC 81 is connected to the output of the operational amplifier 51. The digital subtraction circuit 82 is connected to the output of the ADC 81.

The second operational amplifier 151 is configured as a unity gain buffer, buffering the open circuit voltage VOC(A) onto the non-inverting terminal of the first operational amplifier 51 which is configured as an integrator. The operation of the circuit is then as has already been described for the first embodiment.

The twenty-first embodiment is shown in FIG. 37.

This circuit contains the following elements:

A detection photodiode 7 which is exposed to ambient light

A first reference photodiode 20 which is shielded from ambient light.

An operational amplifier 51 of standard construction.

A second operational amplifier 151

An integration capacitor C_{INT} 52

A switch S1 53.

An Analogue to Digital Converter 81(ADC) circuit of standard construction

The circuit is connected as follows:

The anode of the detection photodiode 7 is connected to ground. The cathode of the detection photodiode 7 is connected to the inverting input of the operational amplifier 51. The non-inverting input of the second operational amplifier 151 is connected to ground. The inverting input and the output of the second operational amplifier 151 are connected together. The anode of the reference photodiode 20 is connected to the output of the second operational amplifier 151. The cathode of the reference photodiode 20 is connected to the non-inverting input of the second operational amplifier 151. The switch S1 53 is connected between the inverting input and the output of the operational amplifier 51. The integration capacitor 52 is connected between the inverting input and the output of the operational amplifier 51. The ADC 81 is connected to the output of the operational amplifier 51. The digital subtraction circuit 82 is connected to the output of the ADC 81.

The second operational amplifier 151 is configured as a unity gain buffer. The reference photodiode 20 is connected so that minus its open circuit voltage VOC(A) is generated at the non-inverting terminal of the first operational amplifier. The operation of the circuit is then as described for the first embodiment.

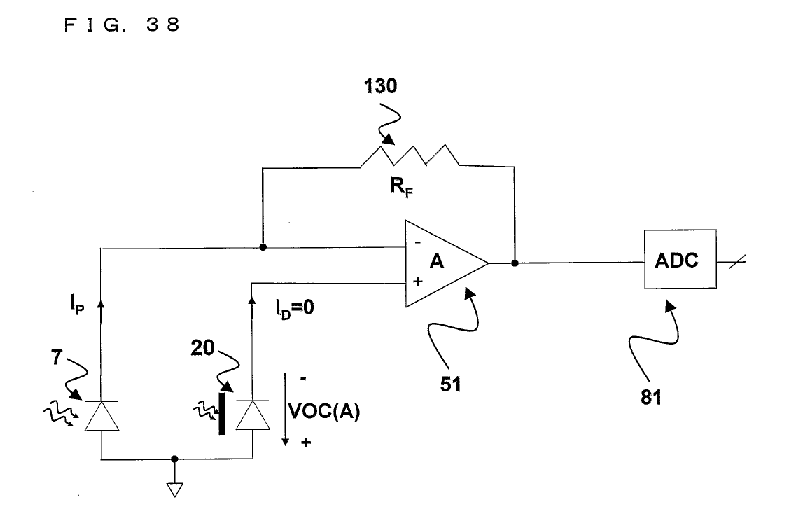

The twenty-second embodiment is shown in FIG. 38.

This circuit contains the following elements:

A detection photodiode 7 which is exposed to ambient light

A reference photodiode 20 which is shielded from ambient light.

An operational amplifier 51 of standard construction.

A resistor R_{F} 130.

An Analogue to Digital Converter 81(ADC) circuit of standard construction

The circuit is connected as follows:

The anode of the detection photodiode 7 is connected to the anode of the reference photodiode 20 which is connected to ground. The cathode of the reference photodiode 20 is connected to the non-inverting input of the operational amplifier 51. The cathode of the detection photodiode 7 is connected to the inverting input of the operational amplifier 51. The resistor R_{F} is connected between the inverting input and the output of the operational amplifier 51. The ADC 81 is connected to the output of the opamp 51.

The circuit is connected so that a bias VOC(A) is generated across the terminals of the detection photodiode 7 as has already been described. The circuit then operates as a transimpedance amplifier as described in the prior art with the voltage at the output of the operational amplifier 51 being dependent on the photocurrent I_{P} generated by the detection photodiode 7.

It will be apparent to one skilled in the art that there are many possible ways of combining the implementations of embodiments 2-18 with those of embodiments 19-22.

The twenty-third embodiment is as the first, second, nineteenth, twentieth, twenty-first and twenty-second embodiments where the reference photodiode is of a different width to the detection photodiode but that in other respects the detection and reference photodiodes may be electrically and optically well matched. An advantage of the twenty-third embodiment is that the reference photodiode can be made much smaller than the detection photodiode since it is not required to source any current.

The twenty-fourth embodiment is as the fifth, sixth, seventh and eighth embodiments where all of the reference photodiodes are of a different width to the detection photodiode but are otherwise electrically and optically well matched.

The twenty-fifth embodiment is as the ninth, tenth, eleventh, twelfth, thirteenth, fourteenth, fifteenth, sixteenth, seventeenth and eighteenth embodiments where the first, second and third reference photodiodes are all of a different width to the first second and third detection photodiodes but are otherwise electrically and optically well matched to the first second and third detection photodiodes.

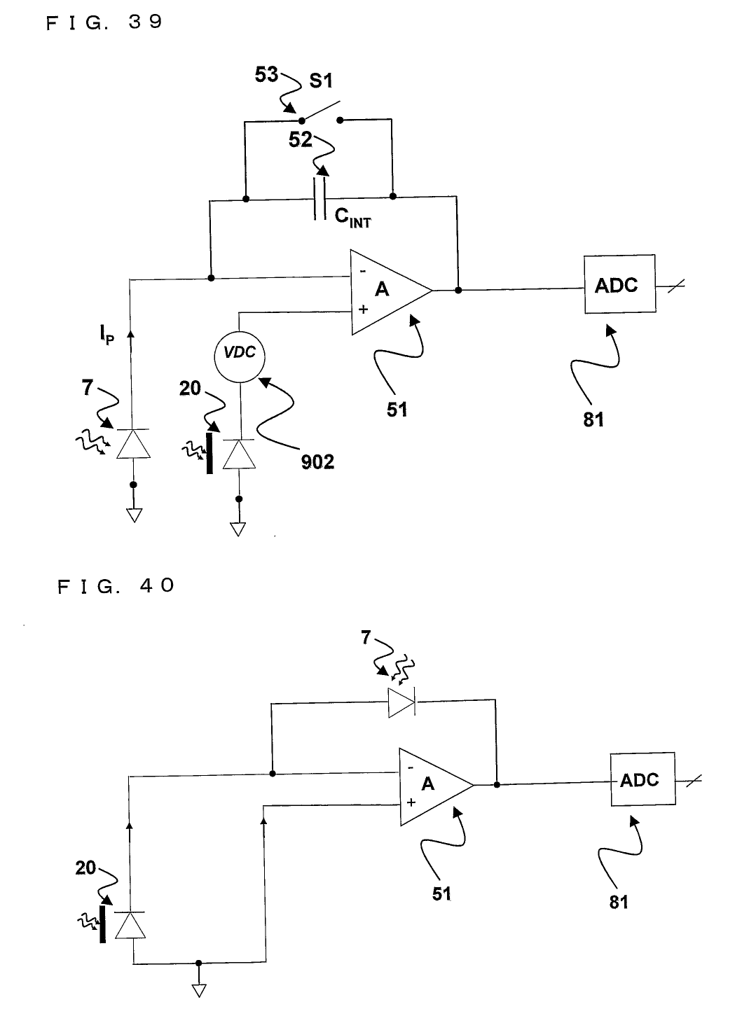

The twenty-sixth embodiment is shown in FIG. 39.

This embodiment is as the first embodiment except that a DC bias source 902 has been connected between the cathode of the reference photodiode 20 and the non inverting input terminal of the operational amplifier 51. The operation of the circuit is as described for the first embodiment, except that the bias voltage applied across the terminals of the detection photodiode 7 is offset from VOC(A) by the chosen value of the DC bias source VDC. An advantage of this embodiment is that the value of VDC may be chosen to compensate for any (non-ideal) offset voltage of the operational amplifier 51. It will be apparent to one skilled in the art that the method of including a DC bias source at the non inverting input terminal can also be combined with any of embodiments 2-25.

The twenty seventh embodiment is shown in FIG. 40. This circuit contains the following elements:

A detection photodiode 7 which is exposed to ambient light

A reference photodiode 20 which is shielded from ambient light.

An operational amplifier 51 of standard construction.

An Analogue to Digital Converter 81(ADC) circuit of standard construction

The circuit is connected as follows:

The anode of the detection photodiode 7 is connected to the cathode of the reference photodiode 20 which is connected to the inverting terminal of the operational amplifier 51. The anode of the reference photodiode 20 is connected to ground. The non inverting input of the operational amplifier 51 is connected to ground. The cathode of the detection photodiode 7 is connected to the output of the operational amplifier 51. The output of the operational amplifier 51 is connected to the input of the ADC 81.

The operation of this circuit differs somewhat from the previous embodiments. The operational amplifier 51 acts so as to maintain the bias at its inverting input equal to the bias at the non-inverting input which is equal to zero volts. Thus a potential of zero volts is maintained across the terminals of the detection photodiode.

The basic operation of the circuit can be most readily understood by first considering the case when the reference photodiode is in darkness. Under these conditions the current through the reference photodiode is zero. Since in the ideal case no current can flow through the operational amplifier 51, a bias is developed across it equal to its open circuit VOC. This bias is representative (though not in this case proportional) to the light level incident upon it.

In the case where the stray light level is non zero, a current ID flows through the reference photodiode 20. Since no current flows through the operational amplifier, the same current must also flow through the detection photodiode. Therefore a potential is developed at the output of the operational amplifier that is reduced from that of the open circuit voltage of the detection photodiode in accordance with the value of ID. Thus the output voltage is representative (though not proportional) to the difference in the light levels incident upon the detection and reference photodiodes. This output voltage can then be measured by the ADC 81 as has already been described.

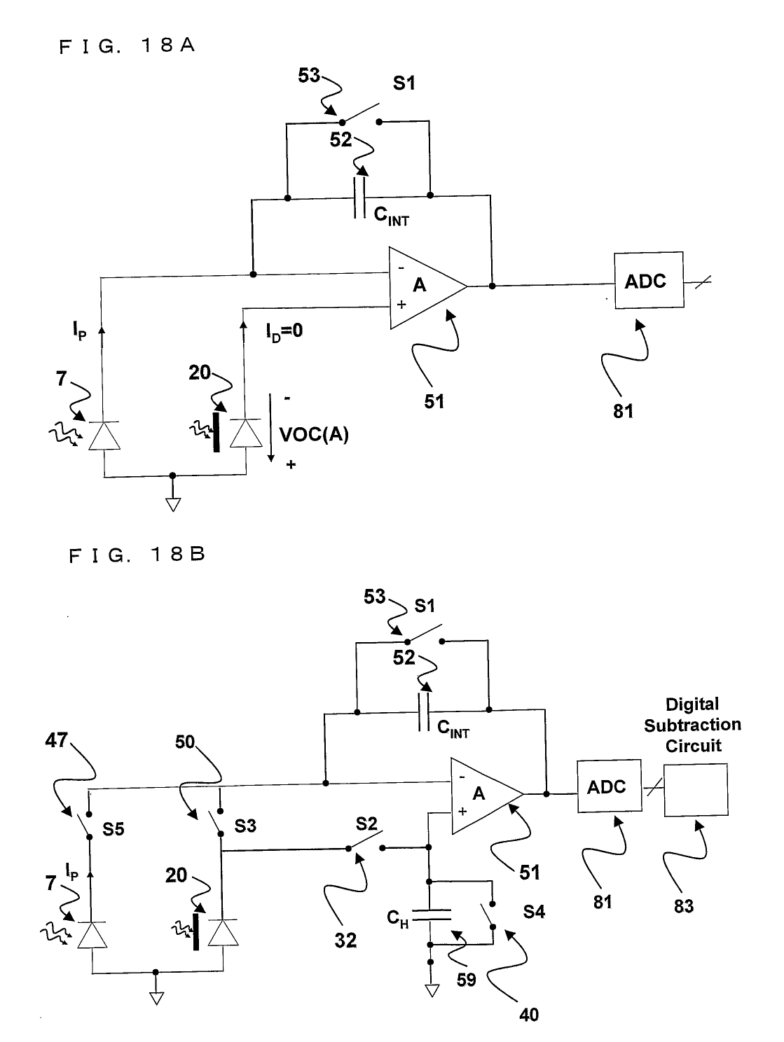

In the twenty seventh embodiment, therefore, the reference photodiode is used to determine a bias current applied to the detection photodiode. This contrasts with the previous embodiments where the reference photodiode is used to determine a bias voltage applied to the detection photodiode. In the previous embodiments, the current in the reference photodiode is controlled, with the resulting voltage being measured and used as a basis for the bias voltage applied to the detection photodiode; in turn, the current from the detection diode is measured and used as a basis for the output signal. In contrast, with the twenty seventh embodiment, the voltage in the reference photodiode is controlled, with the resulting current being measured and used as a basis for the bias current applied to the detection photodiode; in turn, the voltage from the detection diode is measured and used as a basis for the output signal. In effect, the twenty seventh embodiment is based on the same concept as previous embodiments, with “current” essentially being interchanged for “voltage”, so that a current is “copied” from the reference photodiode to the detection photodiode using the analogy shown in FIG. 17C.

The twenty-eighth embodiment is as of any of the previous embodiments where the detection and reference photodiodes are replaced by alternative photosensor elements, for example phototransistors.

It will be readily apparent to the skilled person that combinations other than those explicitly described above are possible.

1. A method of compensating for stray light in a light sensor having a detection photosensor and a reference photosensor, the reference photosensor being for use in compensating for stray light falling on the detection photosensor, and the method comprising using the reference photosensor at least in part to determine a bias voltage applied to the detection photosensor.

2. A method as claimed in claim 1, comprising determining the light level to be sensed by the sensor in dependence upon a current generated by the detection photosensor with the detection photosensor bias voltage applied to it.

3. A method as claimed in claim 1, comprising determining the detection photosensor bias voltage in dependence upon the amount of stray light falling on the reference photosensor.

4. A method as claimed in claim 1, comprising using the reference photosensor to bias the detection photosensor in substantially its most sensitive region of operation.

5. A method as claimed in claim 1, comprising using the reference photosensor to bias the detection photosensor so as to tend to maximise the ratio of the current generated when the light level to be sensed is non-zero to the current generated when the light level to be sensed is zero.

6. A method as claimed in claim 1, comprising deriving the detection photosensor bias voltage from a reference voltage relating to the reference photosensor.

7. A method as claimed in claim 6, wherein the reference voltage is a substantially open circuit voltage developed across the reference photosensor.

8. A method as claimed in claim 6, wherein the reference voltage is the bias voltage required to be applied to the reference photosensor such that a substantially zero current flows therethrough.

9. A method as claimed in claim 6, comprising applying an offset voltage to the reference voltage.

10. A method as claimed in claim 6, comprising arranging for the detection photosensor bias voltage to be substantially the same as the reference voltage.

11. A method as claimed in claim 6, comprising using an operational amplifier to derive the detection photosensor bias voltage from the reference voltage.

12. A method as claimed in claim 10, comprising using an operational amplifier to derive the detection photosensor bias voltage from the reference voltage, wherein the detection photosensor and reference voltage are connected operatively to respective inputs of the operational amplifier, with the operational amplifier being arranged so as to tend to equalise the voltages at the respective inputs, thereby tending to make the bias voltage applied to the detection photosensor equal to the reference voltage.

13. A method as claimed in claim 11, wherein the operational amplifier is a first operational amplifier, and comprising using a second operational amplifier in a feed forward configuration with the first operational amplifier to sense and correct for an offset voltage of the first operational amplifier.

14. A method as claimed in claim 11, wherein the operational amplifier is a first operational amplifier, and comprising using a second operational amplifier to buffer the reference voltage to the first operational amplifier.

15. A method as claimed in claim 11, wherein the operational amplifier is a first operational amplifier, and comprising using a second operational amplifier connected operatively between the reference photosensor and ground.

16. A method as claimed in claim 11, wherein the operational amplifier is a first operational amplifier, and comprising using a second operational amplifier connected operatively between the reference photosensor and the detection photosensor.

17. A method as claimed in claim 6, comprising storing the reference voltage, and determining the light level to be sensed by the sensor in dependence upon a current generated by the reference photosensor with a reference photosensor bias voltage applied to it, the reference photosensor bias voltage being derived from the stored reference voltage using substantially the same circuitry as used to derive the detection photosensor bias voltage from the reference voltage.

18. A method as claimed in claim 17, comprising determining the light level to be sensed by the sensor in dependence upon a current generated by the detection photosensor with the detection photosensor bias voltage applied to it, and said method comprising determining the light level to be sensed by the sensor in dependence upon a subtraction of the detection and reference photosensor currents.

19. A method as claimed in claim 18, comprising converting the currents to respective digital values and performing the subtraction in the digital domain.

20. A method as claimed in claim 17, comprising storing the reference voltage using a capacitor.

21. A method as claimed in claim 1, wherein the reference photosensor is a first reference photosensor, the light sensor having a second reference photosensor also being for use in compensating for stray light falling on the detection photosensor.

22. A method as claimed in claim 6, comprising deriving a bias voltage applied to the second reference photosensor from the reference voltage, wherein the reference photosensor is a first reference photosensor, the light sensor having a second reference photosensor also being for use in compensating for stray light falling on the detection photosensor.

23. A method as claimed in claim 21, comprising determining the light level to be sensed by the sensor in dependence upon a current generated by the second reference photosensor.

24. A method as claimed in claim 23, comprising determining the light level to be sensed by the sensor in dependence upon a current generated by the detection photosensor with the detection photosensor bias voltage applied to it, and said method comprising determining the light level to be sensed by the sensor in dependence upon a sum of or difference between the second reference photosensor current and the detection photosensor current.

25. A method as claimed in claim 24, wherein the sum or difference takes place in the digital domain after conversion of the respective currents to digital.

26. A method as claimed in claim 21, wherein the second reference photosensor and detection photosensors are connected operatively in parallel.

27. A method as claimed in claim 1, wherein the photosensors each comprise at least one photosensitive element.

28. A method as claimed in claim 1, wherein at least one photosensor comprises a plurality of photosensitive elements.

29. A method as claimed in claim 28, wherein at least two photosensors each comprise a plurality of photosensitive elements.

30. A method as claimed in claim 29, wherein at least one cross-connection is provided between an inter-element node of a first photosensor and an inter-element node of a second photosensor.

31. A method as claimed in claim 30, wherein the first photosensor is the detection photosensor and the second photosensor is the reference photosensor.

32. A method as claimed in claim 30, wherein the reference photosensor is a first reference photosensor, the light sensor having a second reference photosensor also being for use in compensating for stray light falling on the detection photosensor, and wherein the first photosensor is the detection photosensor and the second photosensor is the second reference photosensor.

33. A method as claimed in claim 30, wherein the reference photosensor is a first reference photosensor, the light sensor having a second reference photosensor also being for use in compensating for stray light falling on the detection photosensor, and wherein the first photosensor is the first reference photosensor and the second photosensor is the second reference photosensor.

34. A method as claimed in claim 28, wherein the photosensitive elements are connected in series.

35. A method as claimed in claim 27, wherein the or each photosensitive element comprises a photodiode.

36. A method as claimed in claim 35, wherein the or each photosensitive element comprises a lateral photodiode.

37. A method as claimed in claim 27, wherein the or each photosensitive element comprises a phototransistor.

38. A method as claimed in claim 27, wherein the or each photosensitive element comprises a thin film photosensitive element.

39. A method as claimed in claim 38, wherein the or each photosensitive element comprises a silicon thin film photosensitive element.

40. A method as claimed in claim 1, wherein a physical dimension of the reference photosensor is different to the corresponding physical dimension of the detection photosensor.

41. A method as claimed in claim 40, wherein the physical dimension is a width.

42. A method as claimed in claim 41, wherein the reference photosensor width is less than the detection photosensor width.

43. A method as claimed in claim 1, wherein the reference and detection photosensors are adapted nominally to be identical to one another.

44. A method of operating a light sensor having a detection photosensor and a reference photosensor, comprising using a method as claimed in claim 1, to compensate for stray light falling on the detection photosensor by using the reference photosensor at least in part to determine a bias voltage applied to the detection photosensor.

45. A method as claimed in claim 1, wherein the detection photosensor is arranged to receive both the light to be sensed by the sensor and the stray light, and the reference photosensor is arranged to receive substantially only the stray light.

46. A method of measuring a light level comprising using a method as claimed in claim 1, to provide a measurement of the light level with the effects of stray light substantially removed.

47. A method as claimed in claim 1, wherein the light to be sensed comprises ambient light.

48. A method of operating a display device comprising determining an ambient light level using a method as claimed in claim 1, and controlling a property of the display device in dependence upon the determined ambient light level.

49. A method as claimed in claim 48, wherein the property comprises the brightness of the display device, for example the intensity of a backlight of the display device or the brightness of emissive display elements making up a display panel of the display device.

50. A method as claimed in claim 49, wherein the stray light derives from the backlight or emissive display elements, as the case may be.

51. A method as claimed in claim 48, wherein the property comprises the gamma of the display device.

52. A light sensor comprising a detection photosensor and a reference photosensor, the reference photosensor being for use in compensating for stray light falling on the detection photosensor, and the sensor being adapted to use the reference photosensor at least in part to determine a bias voltage applied to the detection photosensor.

53. A display device comprising a backlight and a light sensor as claimed in claim 52 for determining an ambient light level, and means for controlling the intensity of the backlight in dependence upon the determined ambient light level.

54. A display device as claimed in claim 53, wherein the stray light derives from the backlight.

55. A display device as claimed in claim 53, comprising a display substrate on which display circuitry is provided, and wherein the light sensor is provided on the display substrate.

56. A method as claimed in claim 1, wherein for the word “voltage” instead read “current”, and vice versa.
